(19) United States
(12) Patent Application Publication
(10) Pub. No.: US 2025/0286951 A1
(43) Pub. Date: Sep. 11, 2025

(54) CLASSIFICATION OF COMMUNICATION TO PUBLIC SAFETY ANSWERING POINT

(71) Applicant: Intrado Life & Safety, Inc., Longmont, CO (US)

(72) Inventors: Patrick Arsenault, Montreal (CA); John Lawrence Snapp, Everett, WA (US); Aleem A. Mohummed, Montréal (CA); Charles D. Brady, New Waterford, OH (US); Sam R. Bauder, Berthoud, CO (US)

(21) Appl. No.: 18/601,645

(22) Filed: Mar. 11, 2024

(51) Int. Cl. H04M 3/436; H04M 3/51

(52) U.S. Cl. CPC H04M 3/4365; H04M 3/5116; H04M 2242/04

(57) ABSTRACT

Particular example embodiments described herein can provide for a system, an apparatus, and a method for analyzing a communication from an electronic device to a PSAP, determining a classification for the communication, wherein the classification is one of an emergency PSAP classification, a non-emergency PSAP classification, or a not related to PSAP services classification, and sending the communication and the determined classification for the communication to the PSAP. In some examples, communications with the emergency PSAP classification are sent to a high priority queue at the PSAP, communications with the non-emergency PSAP classification are sent to a medium priority queue at the PSAP, and communications with the not related to PSAP service classification are sent to a low priority queue at the PSAP. In some examples, a computer model used to determine the classification for the communication.

### TECHNICAL FIELD

This disclosure relates in general to the field of computing and/or networking and, more particularly, to a system, an apparatus, and a method to enable classifying of communications to a public safety answering point.

### BACKGROUND

A public-safety answering point (PSAP), sometimes called a public-safety access point, is a call center where emergency/non-emergency calls (like police, fire brigade, ambulance) are received and handled. The PSAP is a call center in almost all the countries, including Canada and the United States, where a trained PSAP operator is typically responsible for answering calls to an emergency telephone number for police, firefighting, and ambulance services. Some PSAPs also use voice broadcasting where outgoing voice mail can be sent to many phone numbers at once in order to alert people to a local emergency such as an earthquake or chemical spill.

Some PSAPs have the ability to receive and respond to text messages. Text messages (e.g., SMS messages) are especially useful in areas where weak signal strength, due to distance from the nearest cell site, causes fringe reception, resulting in blocked or dropped calls. Because text messages only require an instant to send, a brief peak in radio propagation (such as a sudden favorable shift in multipath phase alignment) is often enough to allow a message to be sent. Text messages are also useful for the deaf or speech disabled, as it does not require a teletypewriter (TTY) device and as a means of communication when a person is unable to speak (e.g., in a domestic abuse case).

In Canada and the United States, counties are generally bound to provide a PSAP and other emergency services even within municipalities, unless the municipality chooses to opt out and have its own system. Each PSAP has a ‘real’ telephone number that is called when an emergency number (e.g., 911) is dialed or texted. The telecommunications operator is responsible for associating all landline numbers with the most applicable (often the nearest) PSAP, such that when the emergency number is dialed, the call or text is automatically routed to the most suitable PSAP.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a system to enable classifying of communications to a public safety answering point, in accordance with an embodiment of the present disclosure;

FIG. 1B is a simplified block diagram of a system to enable classifying of communications to a public safety answering point, in accordance with an embodiment of the present disclosure;

FIG. 2 is a simplified block diagram of a particular implementation of a communication analysis engine to help enable classifying of communications to a public safety answering point, in accordance with an embodiment of the present disclosure;

FIGS. 3A-3C are simplified block diagrams illustrating example details of a particular implementation to help enable classifying of communications to a public safety answering point, in accordance with an embodiment of the present disclosure;

FIG. 4 is a simplified block diagram illustrating example details of a system to help enable classifying of communications to a public safety answering point, in accordance with an embodiment of the present disclosure;

FIG. 5A-5D are simplified block diagrams illustrating example details of a particular implementation to help enable classifying of communications to a public safety answering point, in accordance with an embodiment of the present disclosure;

FIG. 6 is a simplified block diagram illustrating example details of a particular implementation that includes a confidence score to help enable classifying of communications to a public safety answering point, in accordance with an embodiment of the present disclosure, in accordance with an embodiment of the present disclosure;

FIGS. 7A-7D are a simplified block diagram illustrating example details of a particular implementation of scripts to help enable classifying of a communication to a public safety answering point and/or obtain additional details related to the communication to a public safety answering point, in accordance with an embodiment of the present disclosure;

FIGS. 8A-8C are a simplified block diagram illustrating example details of a particular implementation that includes examples of the classification of communications to help enable classifying of communications to a public safety answering point, in accordance with an embodiment of the present disclosure, in accordance with an embodiment of the present disclosure;

FIGS. 9A and 9B are a simplified block diagram illustrating example details of a particular implementation that includes a subclassification and related subclassification script to help enable classifying of communications to a public safety answering point, in accordance with an embodiment of the present disclosure, in accordance with an embodiment of the present disclosure

FIG. 10 is a simplified block diagram illustrating example details of a data packet to help enable classifying of communications to a public safety answering point, in accordance with an embodiment of the present disclosure;

FIG. 11 is a simplified flowchart illustrating potential operations to help enable classifying of communications to a public safety answering point, in accordance with an embodiment of the present disclosure;

FIG. 12 is a simplified flowchart illustrating potential operations to help enable obtaining details related to a public safety answering point, in accordance with an embodiment of the present disclosure;

FIG. 13 is a simplified flowchart illustrating potential operations to help enable classifying of and/or obtaining details related to communications to a public safety answering point, in accordance with an embodiment of the present disclosure;

FIG. 14 is a simplified flowchart illustrating potential operations to help enable classifying of and/or obtaining details related to communications to a public safety answering point, in accordance with an embodiment of the present disclosure;

FIG. 15 is a simplified flowchart illustrating potential operations to gather information or details to help enable classifying of and/or obtaining details related to communications to a public safety answering point, in accordance with an embodiment of the present disclosure;

FIG. 16 is a simplified flowchart illustrating potential operations to help enable classifying of and/or obtaining details related to communications to a public safety answering point, in accordance with an embodiment of the present disclosure;

FIG. 17 is a simplified flowchart illustrating potential operations to classify communications and use a confidence score to help enable classifying of communications to a public safety answering point, in accordance with an embodiment of the present disclosure;

FIG. 18 is a simplified flowchart illustrating potential operations to gather information or details to help enable classifying of and/or obtaining details related to communications to a public safety answering point, in accordance with an embodiment of the present disclosure;

FIG. 19 is a simplified flowchart illustrating potential operations to identify an event and trigger an event warning, in accordance with an embodiment of the present disclosure;

FIG. 20 is a simplified block diagram illustrating example details of an example computer model inference and computer model training to help enable classifying of communications to a public safety answering point, in accordance with an embodiment of the present disclosure; and

FIG. 21 is a simplified block diagram illustrating examples details of an example neural network architecture to enable classifying of communications to a public safety answering point, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to enabling classifying communications to a public safety answering point, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

A public safety answering point (PSAP) can receive multiple communications that are not related to PSAP services. For example, some PSAPs are able to receive text messages and several of the texts message can be non-emergency text messages, spam text messages, and messages from IoT devices. In addition, some texts and voice calls are prank text or calls or solicitation text or calls. These non-emergency PSAP communications can take up valuable time from an emergency service operator and divert the attention of the emergency service operator away from actual emergency calls. What is needed is a way to filter and classify the communications.

In an example, a system, method, apparatus, means, etc. can enable classifying of communications to a PSAP. In an illustrative example, a communication to a PSAP is sent. For example, an electronic device such as a smart phone or mobile phone can send the PSAP a text message, a voice call, an audio message, or some other type of message. The communication is intercepted by a communication analysis engine before it reaches a human operator at the PSAP and a classification for the communication is determined. If the communication is an audio communication (e.g., voice call), the audio communication is converted to text. In some examples, an unaltered intact copy of the original communication, whether it is a text communication or audio communication, is stored. In some examples, the communication analysis engine can use computer models (e.g., Artificial Intelligence (AI)) to determine the classification for the communication.

The classification of the communication can be an emergency PSAP classification, a non-emergency PSAP communications classification, or a not related to PSAP services (e.g., accidental communications, prank communications, spam, etc.) classification. Based on the classification, the communication can be placed in a queue at the PSAP. More specifically, emergency PSAP communications are placed into a highest priority queue, non-emergency PSAP communications are placed into a medium priority queue, and PSAP communications that are not related to PSAP services are placed into a lowest priority queue. For example, if the communication is classified as an emergency PSAP classification, the communication is sent to a human operator that is monitoring the emergency PSAP communication queue or high priority queue of the PSAP (e.g., an emergency PSAP communication queue). If the communication is classified as a non-emergency PSAP communication, the communication is sent to a human operator that is monitoring the non-emergency PSAP communication queue or medium priority queue of the PSAP (e.g., a non-emergency PSAP communication queue). If the communication is classified as not related to PSAP services (e.g., accidental communications, prank communications, spam, etc.), the communication is sent to a human operator that is monitoring the not related to PSAP services communication queue or low priority queue at the PSAP (e.g., a not related to PSAP services communication queue). In some examples, the communication classified by the communication analysis engine as not related to PSAP services are disregarded and not sent to the PSAP. The same human operator or one or more different human operators may be monitoring the emergency PSAP communication queue, the non-emergency PSAP communication queue, and/or the not related to PSAP services communication queue. By classifying communications to the PSAP as emergency PSAP communications, non-emergency PSAP communications, and not related to PSAP communications, the communication analysis engine can triage the communications and allow an emergency service operator to focus their attention on the emergency PSAP communications.

Sometimes text messages are difficult to classify and/or processes by a PSAP operator because there is so little information in the text message. In an illustrated example, the communication analysis engine can use a script as a guide to help obtain additional information related to the communication to the PSAP. The communication analysis engine can use the script as a guide to engage in a chat or dialogue with the user of the electronic device that initiated the communication. The chat or dialogue can include one or more questions for the user to prompt the user to provide additional details related to the communication to the PSAP. In some examples, the script includes one or more questions for the user and the script is executed, controlled, used as a guide, etc. by a computer model (e.g., a chat bot or some other system designed to simulate a conversation with the user) to prompt the user to provide additional details related to the communication to the PSAP. The communication, one or more questions, and responses to the one or more questions are sent to the human operator at the PSAP. By using a script as a guide to gather more information about the communication to the PSAP, the system can help gather needed details about the communication and allow an emergency service operator to focus their attention on facilitating an appropriate response to the emergency PSAP communications.

In some examples, communications are classified and based on the classification, a specific script for the classification is used as a guide to gather additional details related to the communication. For example, if the classification is a fire emergency classification, a fire emergency script may be used as a guide to gather additional details about the fire emergency. Also, a script can be used as a guide to help determine the classification of the communication. For example, based on responses to questions from the script, the communication analysis engine can use the responses to classify and sometime subclassify the communication. In some examples, computer models, including various types of neural networks and/or large language models (e.g., OpenAl, Llama2, chatbots, etc.), may be trained to classify a communication to a PSAP and/or to execute scripts or dialogs to gather information regarding the communication to the PSAP.

### Example Systems, Apparatuses, and Methods

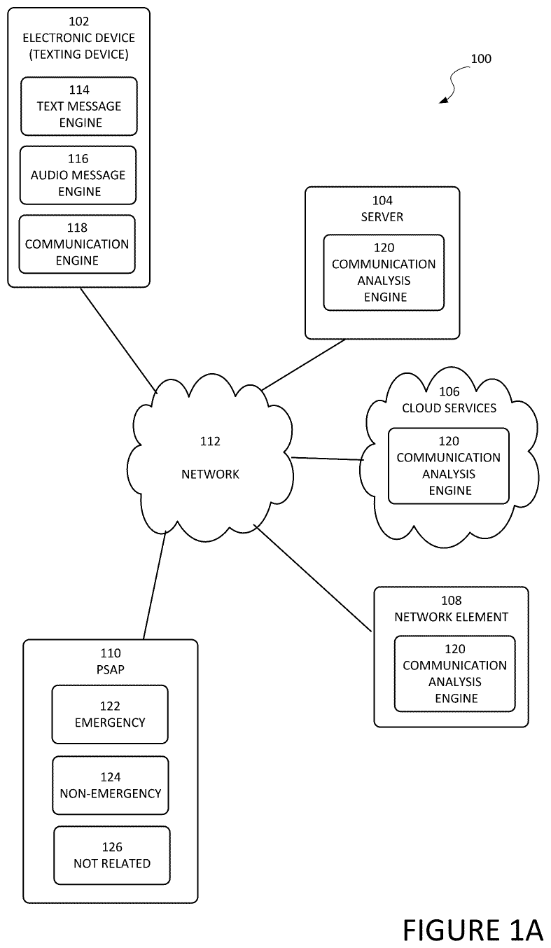

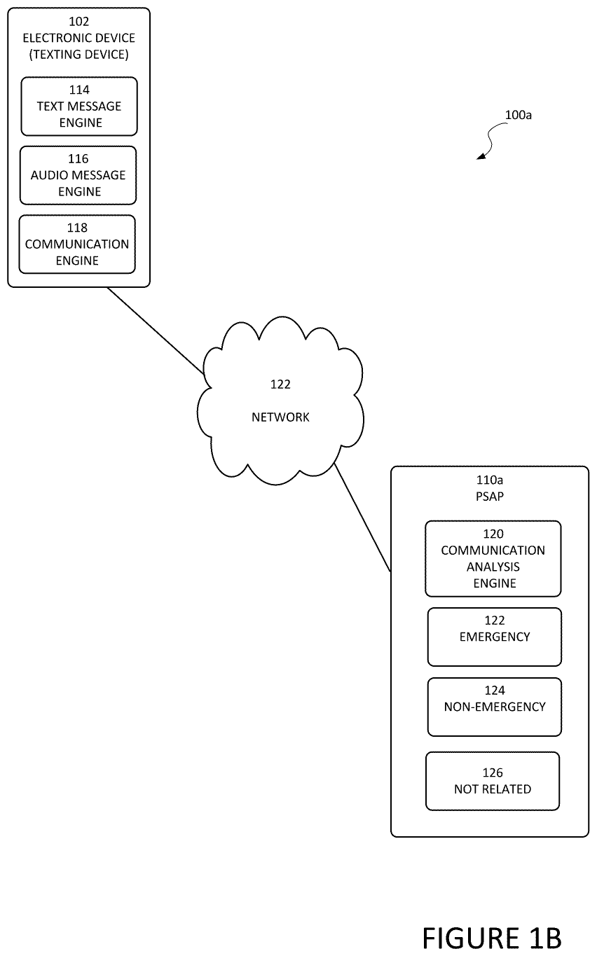

FIG. 1A is simplified block diagram of a particular non-limiting communication system 100 to enable classifying of communications to a PSAP. The communication system 100 can include an electronic device 102, one or more of a server 104, cloud services 106, and/or a network element 108, and a PSAP 110. The electronic device 102, the server 104, cloud services 106, the network element 108, and the PSAP 110 can be in communication with each other using a network 112.

The electronic device 102 can include a text message engine 114, an audio message engine 116, and a communication engine 118. The text message engine 114 can help facilitate the creation, sending, and receiving of text messages (e.g., Short Message/Messaging Service (SMS) messages) by the electronic device 102. The audio message engine 116 can help facilitate the creation, sending, and receiving of audio messages (e.g., voice calls) by the electronic device 102. The communication engine 118 can help facilitate the communication of the text messages and the audio messages by the electronic device 102 to/from the network 112.

The server 104, cloud services 106, and the network element 108 can each include a communication analysis engine 120. The communication analysis engine 120 can received communications from the electronic device 102 and classify the communications. More specifically, the communication analysis engine 120 can classify the communications from the electronic device 102 as emergency PSAP communications, non-emergency PSAP communications, not related to PSAP services communication (e.g., accidental communications, prank communications, spam, etc.), etc. In some examples, the communication analysis engine 120 can subclassify emergency PSAP communications based on the type of emergency (e.g., fire, medical condition, robbery, etc.) or non-emergency (e.g., suspicious activity reported, loud noises from neighbor, etc.). For example, the communication analysis engine 120 can use key words from the communication to help classify, and in some examples subclassify, the communication to the PSAP. In other examples, the communication analysis engine 120 can use machine learning to help classify, and in some examples subclassify, the communication to the PSAP.

In some examples, the communication analysis engine 120 can help obtain additional information related to the communication to the PSAP 110. More specifically, in an illustrated example, the communication analysis engine 120 can use a script as a guide to engage in a chat or dialogue with the user of the electronic device that initiated the communication. The chat or dialogue can include one or more questions for the user to prompt the user to provide additional details related to the communication to the PSAP 110. In some examples, a script with one or more questions for the user is executed, controlled, used as a guide, etc. by a computer model (e.g., a chat bot or some other system designed to simulate a conversation with the user) to prompt the user to provide additional details related to the communication to the PSAP. The communication, one or more questions, and responses to the one or more questions are sent to the human operator at the PSAP 110. By using a script as a guide to gather more information about the communication to the PSAP 110, the system can help gather needed details about the communication and allow an emergency service operator to focus their attention on facilitating an appropriate response to the PSAP communications.

The PSAP 110 can include an emergency PSAP communication queue 122, a non-emergency PSAP communication queue 124, and a not related to PSAP services communication queue 126. Communications classified by the communication analysis engine 120 as emergency PSAP communications can be sent to the emergency PSAP communication queue 122 to be reviewed by a human operator at the PSAP, communications classified by the communication analysis engine 120 as non-emergency PSAP communications can be sent to the non-emergency PSAP communication queue 124 to be reviewed by a human operator at the PSAP, and communications classified by the communication analysis engine 120 as not related to PSAP services (e.g., accidental communications, prank communications, spam, etc.) can be sent to the not related to PSAP services communication queue 126 to be reviewed by a human operator at the PSAP.

The same human operator at the PSAP may review the emergency PSAP communications, the non-emergency PSAP communications, and/or the communications classified as not related to PSAP services sent to the PSAP or a portion of the emergency, the non-emergency, and/or the not related to PSAP services communications sent to the PSAP. More specifically, a first human operator at the PSAP may review the emergency PSAP communications and the non-emergency PSAP communications and a second human operator at the PSAP may review the communications classified as not related to PSAP services. In yet other examples, a first human operator and the second human operator at the PSAP may review the emergency PSAP communications, the second human operator at the PSAP may also review the non-emergency PSAP communications, and a third human operator at the PSAP may review the communications classified as not related to PSAP services. Note that the examples above of human operators at the PSAP reviewing communications are non-limiting examples and one or more human operators at the PSAP can review one or more of the communications to the PSAP. By classifying PSAP communications into emergency PSAP communications, non-emergency PSAP communications, and communications classified as not related to PSAP services, the communication analysis engine 120 can triage the communications and allow a human operator at the PSAP (e.g., an emergency service operator) to focus their attention on the emergency PSAP communications. In some examples, the communications that are classified by the communication analysis engine 120 as not related to PSAP services are disregarded and not sent to the PSAP 110.

Turning to FIG. 1B, FIG. 1B is simplified block diagram of a particular non-limiting communication system 100a to enable classifying of communications to a PSAP. The communication system 100a can include the electronic device 102 and a PSAP 110a. The electronic device 102 and the PSAP 110a can be in communication with each other using the network 112.

The electronic device 102 can include the text message engine 114, the audio message engine 116, and the communication engine 118. The PSAP 110 can include the communication analysis engine 120, the emergency PSAP communication queue 122, the non-emergency PSAP communication queue 124, and the not related to PSAP services communication queue 126. The communication analysis engine 120 can receive communications from the electronic device 102 and classify the communications. In some examples, the communication analysis engine 120 can obtain additional information about the communication (e.g., using a chatbot). Communications classified by the communication analysis engine 120 as emergency PSAP communications can be sent to the emergency PSAP communication queue 122, communications classified by the communication analysis engine 120 as non-emergency PSAP communications can be sent to the non-emergency PSAP communication queue 124, and communications classified by the communication analysis engine 120 as not related to PSAP services can be sent to the not related to PSAP services communication queue 126. The communications in the emergency PSAP communication queue 122, the non-emergency PSAP communication queue 124, and the not related to PSAP services communication queue 126 can be reviewed by a human PSAP operator. By classifying PSAP communications into emergency PSAP communications, non-emergency PSAP communications, and communications classified as not related to PSAP services, the communication analysis engine 120 can triage the communications and allow a human operator at the PSAP (e.g., an emergency service operator) to focus their attention on the emergency PSAP communications. In some examples, communications that are classified by the communication analysis engine 120 as not related to PSAP services (e.g., accidental communications, prank communications, spam, etc.) are disregarded and not sent to the PSAP 110.

It is to be understood that other embodiments and implementations may be utilized, and structural changes may be made without departing from the scope of the present disclosure. Substantial flexibility is provided by the system and method in that any suitable arrangements and configuration may be provided without departing from the teachings of the present disclosure. For purposes of illustrating certain example techniques to enable classifying of communications to a PSAP, the following foundational information may be viewed as a basis from which the present disclosure may be properly explained. A number of prominent technological trends are currently afoot (e.g., more computing devices, more online video services, more Internet traffic), and these trends are changing the media delivery landscape. One trend is the ability to communicate with a PSAP using text messaging. Text-to-911 is the ability to send a text message to reach 911 emergency call takers from your mobile phone or device.

A PSAP, sometimes called a public-safety access point, is a call center where emergency/non-emergency calls (like police, fire brigade, ambulance) initiated by any landline, mobile or Voice Over Internet Protocol (“VOIP”) are received. When a communication is sent to a PSAP, a highly trained professional human PSAP operator is expected to respond to the communication. However, PSAP operators are part of an industry under immense pressure because of understaffing and a host of other issues. PSAP centers are struggling with surging call and text volumes, complex compounded emergencies, outdated technologies, and insufficient support. Because operators at the PSAPs need to handle each call and text, calls and text to the PSAP that are not related to PSAP services (e.g., accidental communications, prank communications, spam, etc.) waste precious time of the PSAP operators and prevent the PSAP operators from handling real emergencies. This adds to the stress the PSAP operators face every day and is another deterrent to employee retention. In addition, as more and more machine generated text messages (from alarm sensors, spam bots, etc.) continue to flood the PSAPs, the problem will only get exacerbated. What is needed is a system, an apparatus, and a method to help enable classifying of communications to a PSAP.

A system, method, apparatus, means, etc. to enable classifying of communications to a PSAP can help resolve these issues (and others). In an example, a system and method can include a communication analysis engine (e.g., the communication analysis engine 120) to help enable classifying of communications to a PSAP. In an illustrative example, an electronic device (e.g., the electronic device 102) can send a PSAP (e.g., the PSAP 110) a text message, a voice call, an audio message, or some other type of communication. The communication is intercepted by the communication analysis engine before it reaches a human operator at the PSAP. If the communication is an audio communication, the audio communication is converted to text by a voice to text engine (e.g., the voice to text engine 206) in the communication analysis engine. The text of the intercepted communication to the PSAP, including voice communications converted to text, can be translated into a preferred language of the PSAP operator.

A classification engine (e.g., the classification engine 210) in the communication analysis engine can assign a classification to the communication. In addition, the classification engine can be used to obtain additional information about the communication. More specifically, in an illustrated example, the communication analysis engine can use a script as a guide to engage in a chat or dialogue with the user of the electronic device that initiated the communication. The chat or dialogue can include one or more questions for the user to prompt the user to provide additional details related to the communication. In some examples, the script is executed or controlled by a computer model (e.g., a chat bot or some other system designed to simulate a conversation with the user).

In some examples, the classification engine in the communication analysis engine can use key words from the communication to help classify the communication to the PSAP. In other examples, the classification engine in the communication analysis engine can use machine learning to help classify the communication to the PSAP. More specifically, the communication analysis engine can assign an emergency PSAP classification to the communication, a non-emergency PSAP classification to the communication, or a not related to PSAP services classification to the communication. If the classification is an emergency PSAP classification, the communication is sent to a high priority queue in the PSAP (e.g., the emergency PSA communication queue 122 in the PSAP 110) to be reviewed by a human operator at the PSAP. If the classification is a non-emergency PSAS classification, the communication is sent to a non-emergency PSAP communication queue or medium priority queue of the PSAP (e.g., a non-emergency PSAP communication queue 124) to be reviewed by a human operator at the PSAP. If the communication is classified by the communication analysis engine as not related to PSAP services (e.g., accidental communications, prank communications, spam, etc.) the communication is sent to a not related to PSAP services communication queue or low priority queue at the PSAP (e.g., a not related to PSAP services communication queue 126) to be reviewed by a human operator at the PSAP. In some examples, the communication classified by the communication analysis engine as not related to PSAP services is disregarded and not sent to the PSAP. By classifying emergency PSAP communications, non-emergency PSAP communications, and not related to PSAP communications from the electronic device to the PSAP, the communication analysis engine can triage the communications and allow an emergency service operator at the PSAP to focus their attention on the emergency PSAP communications.

In some examples, the classification engine in the communication analysis engine can analyze the communication to the PSAP to determine a classification for the communication and assign a confidence score to the classification. When the communication and classification for the communication are sent to the PSAP, the confidence score is also sent to PSAP. In some examples, based on the confidence score, the human PSAP operator can make a decision about whether or not the classification for the communication should be changed (e.g., from a not related to PSAP services classification to a non-emergency classification or from a non-emergency classification to an emergency classification).

In other examples, the system can use the confidence score to determine if the classification for the communication should be changed. More specifically, the system can determine if the confidence score is above a threshold for the classification. For example, for non-emergency classifications, the threshold confidence score may be 0.6 and for communications classified as a not related to PSAP services communication, the threshold confidence score may be 0.9. If the confidence score is above a threshold for the classification, the communication is processed according to the assigned classification. For example, if the communication was assigned a not related to PSAP services classification and the confidence score was above the threshold confidence score of 0.9, then the communication can be sent to the not related to PSAP services communication queue or low priority queue at the PSAP. If the confidence score is not above a threshold for the classification, then the communication is processed as an emergency PSAP communication. For example, if the communication was assigned a non-emergency PSAP classification and the confidence score was below the threshold confidence score of 0.6, then the communication is re-classified as an emergency PSAP classification. Note that the confidence score for each classification can be any value (e.g., any value between zero (0) and one (1)) or indicator that represents the probability of a correct classification of the communication, depending on design choice and design constraints. The threshold value for a not related to PSAP services classification should be high enough to avoid emergency communications and non-emergency communications being sent to the lowest priority queue. Also, the threshold value for a non-emergency PSAP classification should be high enough to avoid the classification of an emergency PSAP communication as a non-PSAP emergency communication. In some examples, a human (e.g., a human PSAP operator) can make the decision as to whether or not the confidence score is high enough to avoid re-classification of the communication. In other examples, the system can make the decision as to whether or not the confidence score is high enough to avoid re-classification of the communication.

In some examples, additional details related to the communication to the PSAP are determined. More specifically, a script execution engine (e.g., the script execution engine 212) can be used to send one or more questions from a script in a script database (e.g., the scripts database 216) that is associated with the classification of the communication to the electronic device that initiated the communication and through the script, a user of the electronic device can be prompted to provide additional details related to the communication to the PSAP. In some examples, the script execution engine can be an AI chat bot that engages in a communication to gather more information about the circumstances related to the communication as opposed to strictly following a linear type script. Also, metadata related to the communication can be analyzed to determine additional details related to the communication to the PSAP. In addition, the electronic device can be used (e.g., the camera of the electronic device, the microphone of the electronic device, the GPS of the electronic device, etc.) to determine additional details related to the communication to the PSAP.

In some examples, communications are classified and based on the classification, a specific script for the classification is used as a guide to gather additional details related to the communication. For example, if the classification is a fire emergency classification, a fire emergency script may be used as a guide to gather additional details about the fire emergency. Also, a script can be used as a guide to help determine the classification of the communication. For example, based on responses to one or more questions from the script, the communication analysis engine can use the responses to classify the communication. The communication and additional details related to the communication are sent to the human operator at the PSAP. If the communication and additional details are in a language other than the preferred language of the human operator at the PSAP, the communication and additional details are translated into the language preferred by the human operator at the PSAP by a translation engine (e.g., the translation engine 208 can convert the communication and additional details related to the communication into English).

In some examples, the system can determine if the communication was sent by a human using the electronic device. For example, the system can use a prompt (e.g., press “1” to continue, etc.) or some other means to determine if the communication was sent by a human using the electronic device. If the communication was sent by a human using the electronic device, a chat or dialogue is initiated with the human using the electronic device to gather more details related to the communication to the PSAP. For example, the script execution engine can be used to send one or more questions from a script in the scripts database to the electronic device and a user of the electronic device can be prompted to provide additional details related to the communication to the PSAP.

If the system determines that the communication was not sent by a human, the system can determine if the electronic device is a device that is related to PSAP services. For example, the system can determine if the electronic device that sent the communication is an IoT device such as a flood detector, security camera, smoke detector, carbon monoxide detector, or some other device that is related to PSAP services. If the electronic device that sent the communication is a device that is related to PSAP services, the electronic device is queried to gather more details related to the communication to the PSAP. If the electronic device that sent the communication is not a device that is related to PSAP services, for example, a known spam messaging center, the communication is sent to a human operator at the not related to PSAP services communication queue or low priority queue at the PSAP (e.g., the not related to PSAP services communication queue 126). In some examples, the communication sent by the device that is not related to PSAP services is disregarded and not sent to the PSAP.

In some examples, communications to a PSAP are analyzed to determine if they are related to a same event (e.g., an earthquake, flood, pandemic outbreak, chemical spill, etc.). If the communications are related to the same event, an event warning is triggered and the local and/or the federal government can be alerted to the event. Based on the event warning being triggered, a message related to the event can be broadcast. For example, if the event is an earthquake, instructions about what to do in an earthquake and/or what to do after an earthquake can be broadcast to the public in the areas affect by the earthquake.

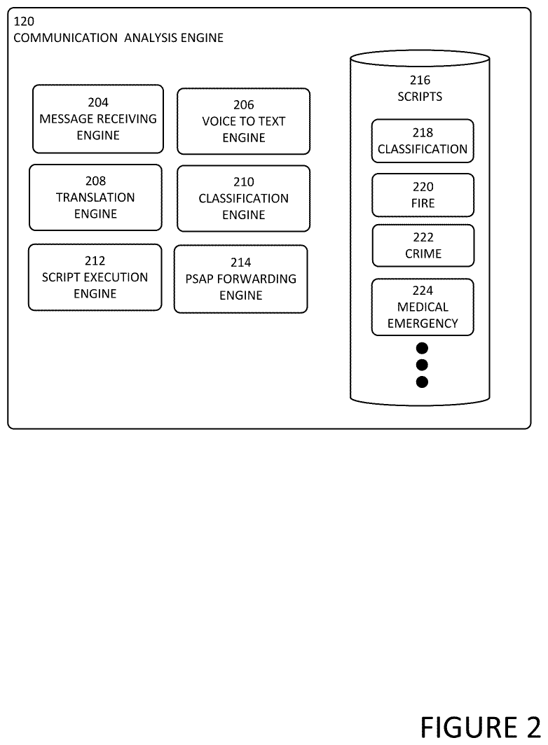

Turning to FIG. 2, FIG. 2 is a simplified block diagram illustrating example details of a particular non-limiting implementation of the communication analysis engine 120 of FIGS. 1A and 1B. The communication analysis engine 120 can include a message receiving engine 204, a voice to text engine 206, a translation engine 208, a classification engine 210, a script execution engine 212, a PSAP forwarding engine 214, and a scripts database 216.

The message receiving engine 204 receives text messages and audio communication or voice messages. The voice to text engine 206 converts audio communication and voice messages into text. The translation engine 208 translates received text messages and the text of audio communication and voice message into a preferred language of the PSAP operator. For example, if the preferred language of the human PSAP operator is English, then the translation engine will convert received text messages and the text of audio communication into English. The translation engine 208 can also translate any scripts or communications with the user of the electronic device 102 that originated the communication into a preferred language of the user of the electronic device 102.

The classification engine 210 can be configured to analyze the received communication and classify the received communication. For example, the received communication can be classified as an emergency PSAP communication, a non-emergency PSAP communication, or as a communication not related to PSAP services (e.g., accidental communications, prank communications, spam, etc.).

In some examples, the classification engine 210 can classify the emergency PSAP communication or the non-emergency PSAP communication into a specific type of emergency PSAP communication or non-emergency PSAP communication. For example, if the communication is classified as an emergency PSAP communication, the classification engine 210 can further classify the emergency PSAP communication as a fire related communication, a medical emergency related communication, a crime related communication, etc.

The scripts database 216 can include scripts that can be associated with gathering more information or data related to a communication, scripts to help classify the communication, scripts that can be associated with communications that have an emergency designation or non-emergency classification, scripts that can be associated with a specific type of emergency PSAP communication or non-emergency PSAP communication, and/or other scripts that may be used by the system. For example, one or more scripts in the scripts database 216 can be used to obtain additional information about a communication to a PSAP. More specifically, the communication classification script 218 can be used as an initial contact script as a guide to obtain more information about a communication to the PSAP. For example, the initial communication script 218 can be used by a chatbot as a guide to engage in a chat or dialogue with the user of the electronic device that initiated the communication to obtain more information about the communication. In some examples, responses to the initial communication script 218 can be used by the classification engine 210 to help classify a communication. If the classification is a fire related classification, a fire related script 220 from the scripts database 216 can be used to obtain more information about the communication, if the classification is a crime related communication, a crime related script 222 from the scripts database 216 can be used to obtain more information about the communication, if the classification is a medical emergency classification, a medical emergency script 224 from the scripts database 216 can be used to obtain more information about the communication.

The scripts in the scripts database 216 can be in different languages to match the language of the communication (e.g., if the communication was a text in Spanish, questions to the user based on the script from the script database will be in Spanish). For example, if the received text message or text of an audio communication from the electronic device 102 is in Spanish, then the questions or statements generated by the script execution engine 212 can be in Spanish. In other examples, the questions or statements generated by the script execution engine 212 using the scripts are translated before being sent to a user to obtain additional details related to a communication.

The script execution engine 212 executes the script from the scripts database 216 for the communication. In some examples, the script from the script database 216 is a linear script where the script execution engine 212 communicates one or more questions and/or one or more statements to the electronic device 102 that initialed the communication. In other examples, the script from the script database 216 is a guide or outline that is used by the script execution engine 212 to gather more information about the circumstances related to the communication. More specifically, the script execution engine 212 can be a chat bot that uses the script as a guide to engage in a communication to gather more information about the circumstances related to the communication to the PSAP as opposed to strictly following a linear type script.

Once information about the circumstances related to the communication has been gathered, the PSAP forwarding engine 214 forwards the communication and gathered information to the PSAP 110. If the communication was classified, the PSAP forwarding engine 214 can forward the communication and gathered information to the emergency PSA communication queue 122 in the PSAP 110 or the non-emergency PSAP communication queue 124 in the PSAP, depending on the classification of the communication by the classification engine 210.

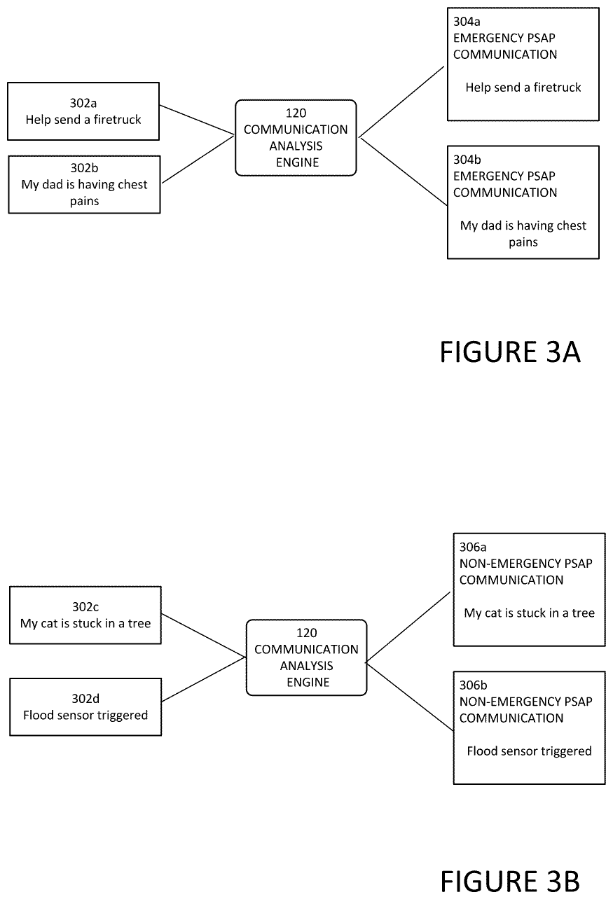

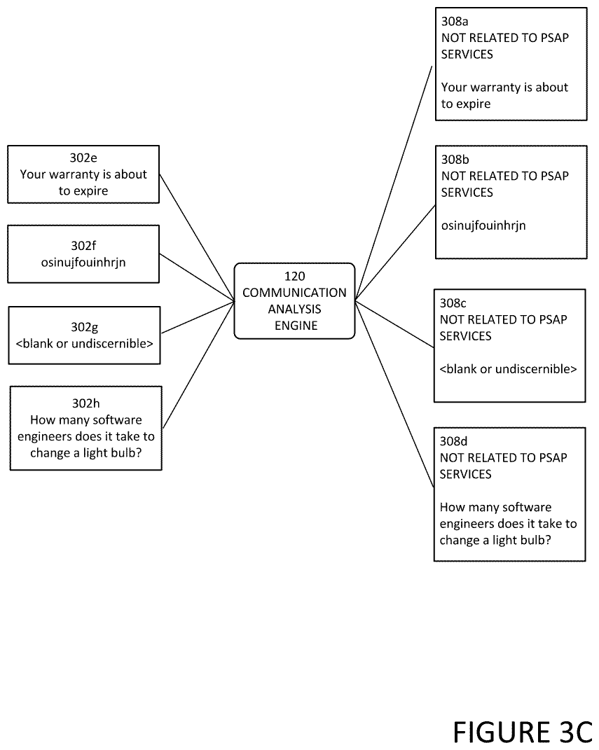

Turning to FIG. 3A, FIG. 3A is a simplified block diagram illustrating specific example details of a system, apparatus, and method to help to enable classifying of communications to a PSAP. In an illustrative example, the communication analysis engine 120 can received communications (e.g., from the electronic device 102) and classify the communications. More specifically, the communication analysis engine 120 can receive communication 302a and communication 302b. Each of the communication 302a and the communication 302b can be a text message, audio message (e.g., voice call), or some other type of message. If the communication 302a and/or the communication 302b are an audio message, the audio message is converted to text by voice to text engine 206, illustrated in FIG. 2.

As illustrated in FIG. 3A, the communication 302a and the communication 302b are related to emergency PSAP services. Using keywords, machine learning, or some other means, the communication analysis engine 120 can analyze the communication 302a and designate it as being an emergency PSAP communication 304a and analyze the communication 302b and designate it as being an emergency PSAP communication 304b. For example, the communication analysis engine 120 can use machine learning to help classify communications 302a and 302b as emergency PSAP communications. The designation as being an emergency PSAP communication may be a flag in a packet that is set, a header bit or bytes in a packet, or some other indication that a communication is an emergency PSAP communication.

Turning to FIG. 3B, FIG. 3B is a simplified block diagram illustrating specific example details of a system, apparatus, and method to help to enable classifying of communications to a PSAP. In an illustrative example, the communication analysis engine 120 can received communications (e.g., from the electronic device 102) and classify the communications. More specifically, the communication analysis engine 120 can receive communication 302c and communication 302d. Each of the communication 302c and the communication 302d can be a text message, audio message (e.g., voice call), or some other type of message. If the communication 302c and/or the communication 302d are an audio message, the audio message is converted to text by voice to text engine 206, illustrated in FIG. 2.

As illustrated in FIG. 3B, the communication 302c and the communication 302d are related to non-emergency PSAP services. Using keywords, machine learning, or some other means, the communication analysis engine 120 can analyze the communication 302c and designate it as being a non-emergency PSAP communication 306a and analyze the communication 302d and designate it as being a non-emergency PSAP communication 306b. For example, the communication analysis engine 120 can use machine learning to help classify communications 302c and 302d as non-emergency PSAP communications. The designation as being a non-emergency PSAP communication may be a flag in a packet that is set, a header bit or bytes in a packet, or some other indication that a communication is a non-emergency PSAP communication.

Turning to FIG. 3C, FIG. 3C is a simplified block diagram illustrating specific example details of a system, apparatus, and method to help to enable classifying of communications to a PSAP. In an illustrative example, the communication analysis engine 120 can received communications (e.g., from the electronic device 102) and classify the communications. More specifically, the communication analysis engine 120 can receive communications 302e-302h. Each of the communications 302e-302h can be a text message, audio message (e.g., voice call), or some other type of message. If a communication 302e-302h is an audio message, the audio message is converted to text by voice to text engine 206, illustrated in FIG. 2.

As illustrated in FIG. 3C, the communications 302e-302h are not related to PSAP services. Using keywords, machine learning, or some other means, the communication analysis engine 120 can analyze the communication 302e (a spam communication) and designate it as being a not related to PSAP services communication 308a, analyze the communication 302f (an accidental or gibberish communication) and designate it as being a not related to PSAP services communication 308b, analyze the communication 302g (an accidental communication) and designate it as being a not related to PSAP services communication 308c, and analyze the communication 302h (a prank communication) and designate it as being a not related to PSAP services communication 308d. For example, the communication analysis engine 120 can use machine learning to help classify communications 302e-302h as not related to PSAP services communications. The designation as being not related to PSAP services may be a flag in a packet that is set, a header bit or bytes in a packet, or some other indication that a communication is not related to PSAP services.

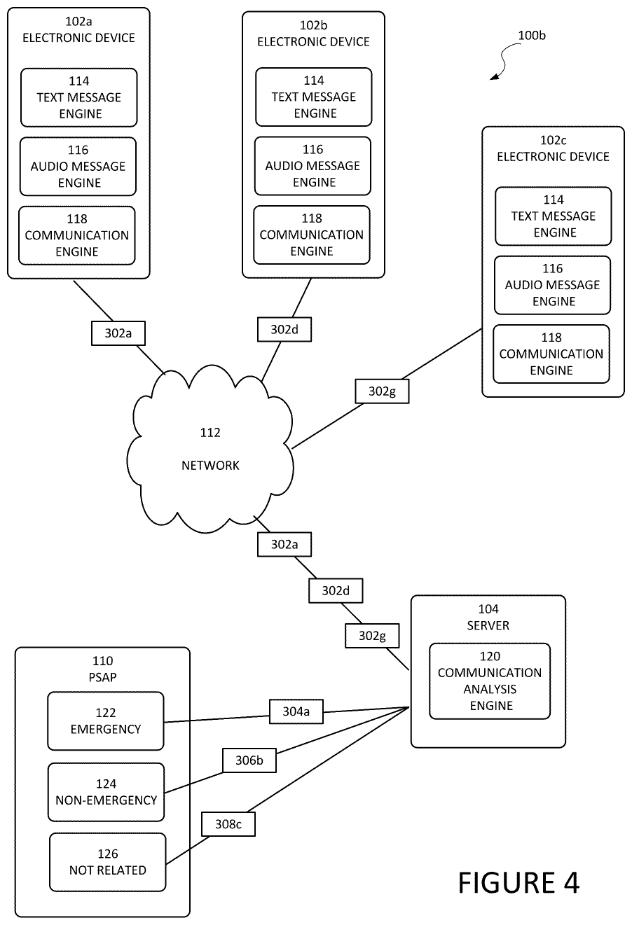

Turning to FIG. 4, FIG. 4 is simplified block diagram illustrating examples details of a particular non-limiting communication system 100b to enable classifying of communications to a PSAP. The communication system 100b can include an electronic device 102a, an electronic device 102b, an electronic device 102c, the server 104, and the PSAP 110. The communication system 100b can also include cloud services 106 (not shown), and/or the network element 108 (not shown). The electronic device 102, the server 104, and the PSAP 110 can be in communication with each other using the network 112.

Each of the electronic devices 102a-102c can include the text message engine 114, the audio message engine 116, and the communication engine 118. The server 104 can include the communication analysis engine 120. The PSAP 110 can include the emergency PSAP communication queue 122, the non-emergency PSAP communication queue 124, and the not related to PSAP services communication queue 126.

As illustrated in FIG. 4, the electronic device 102a can send the communication 302a (FIG. 3A) to the PSAP 110, the electronic device 102b can send the communication 302d (FIG. 3B) to the PSAP 110, and the electronic device 102c can send the communication 302g (FIG. 3C) to the PSAP 110. The communication analysis engine 120 can intercept the communications 302a, 302d, and 302g and, using keywords, machine learning, or some other means, classify the communications. More specifically, the communication analysis engine 120 can classify the communication 302a as the emergency PSAP communication 304a (FIG. 3A), the communication 302d as the non-emergency PSAP communication 306b (FIG. 3B), and the communication 302g as a not related to PSAP services communication 308c (FIG. 3C). The communication analysis engine 120 can send the emergency PSAP communication 304a to the emergency PSA communication queue 122 in the PSAP 110, the non-emergency PSAP communication 306b to the non-emergency PSAP communication queue 124 in the PSAP 110, and the not related to PSAP services communication 308c to the not related to PSAP services communication queue 126. By classifying emergency PSAP communications, non-emergency PSAP communications, and not related to PSAP communications from the electronic devices 102a-102c to the PSAP 110, the communication analysis engine 120 can triage the communications and allow an emergency service operator to focus their attention on the emergency PSAP communications. In some examples, the communication analysis engine 120 does not send or forward the non-emergency PSAP communication 308c to the PSAP 110.

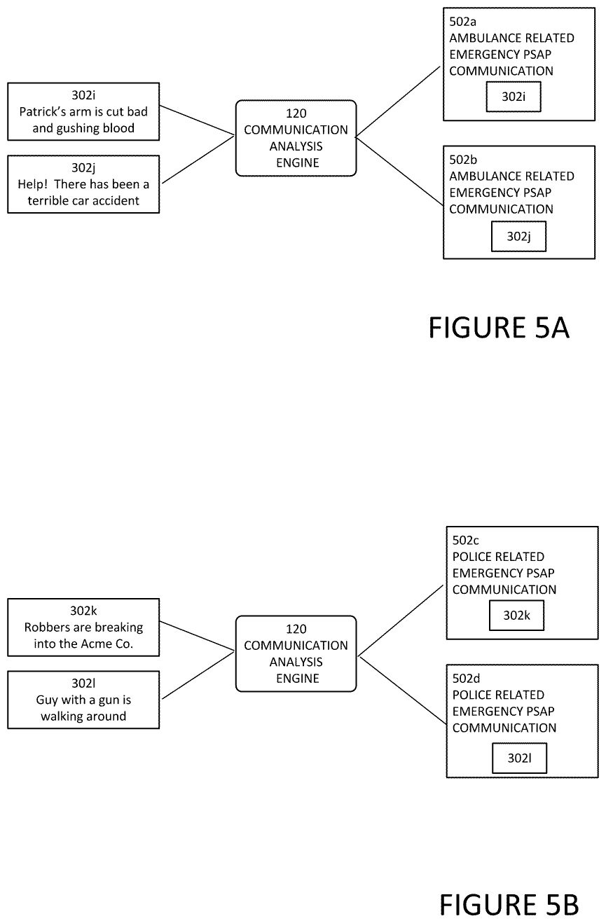

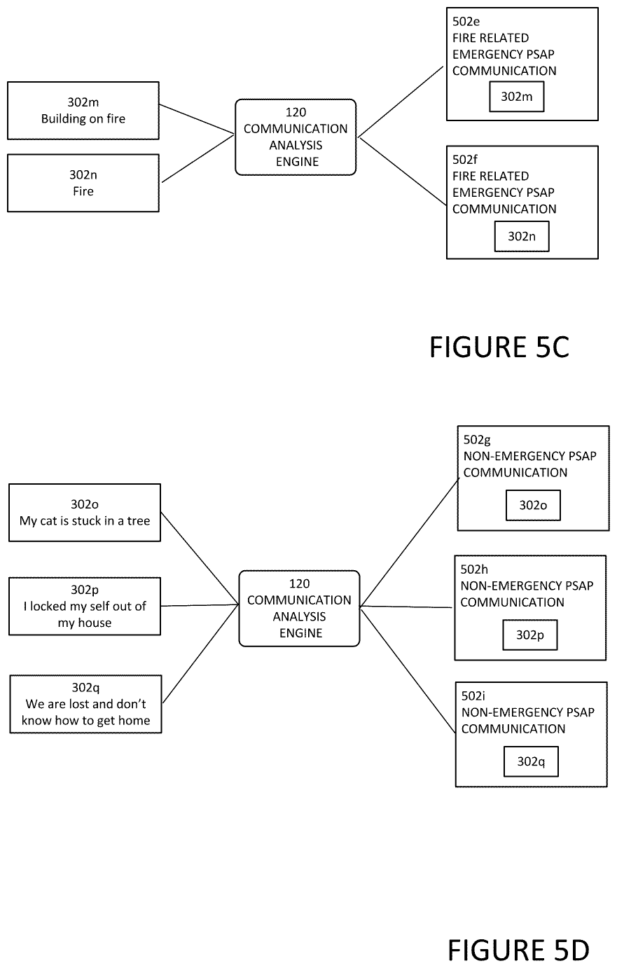

Turning to FIG. 5A, FIG. 5A is a simplified block diagram illustrating specific example details of a system, apparatus, and method to help to enable classifying of communications to a PSAP. In an illustrative example, the communication analysis engine 120 can receive communications (e.g., from the electronic device 102) and classify the communications. More specifically, the communication analysis engine 120 can receive communication 302i and communication 302j. Each of the communication 302i and the communication 302i can be a text message, audio message (e.g., voice call), or some other type of message. If the communication 302i and/or the communication 302j are an audio message, the audio message is converted to text by voice to text engine 206, illustrated in FIG. 2.

As illustrated in FIG. 5A, the communication 302i and the communication 302j are related to emergency PSAP services and more specifically are related to ambulance services. Using keywords, machine learning, or some other means, the communication analysis engine 120 can analyze the communication 302i and the communication 302j and designate them as being medical (ambulance) related emergency PSAP communications. For example, the communication analysis engine 120 can use machine learning to help classify communications 302i and 302j as medical related emergency PSAP communications. The communication analysis engine 120 can encapsulate the communication 302i, along with other details related to the communication 302i (e.g., as obtained using a script as a guide or other means) in a medical related emergency PSAP communication 502a and encapsulate the communication 302j, along with other details related to the communication 302j (e.g., as obtained using a script as a guide or other means) in a medical related emergency PSAP communication 502b.

Turning to FIG. 5B, FIG. 5B is a simplified block diagram illustrating specific example details of a system, apparatus, and method to help to enable classifying of communications to a PSAP. In an illustrative example, the communication analysis engine 120 can receive communications (e.g., from the electronic device 102) and classify the communications. More specifically, the communication analysis engine 120 can receive communication 302k and communication 302l. Each of the communication 302k and the communication 302l can be a text message, audio message (e.g., voice call), or some other type of message. If the communication 302k and/or the communication 302l are an audio message, the audio message is converted to text by voice to text engine 206, illustrated in FIG. 2.

As illustrated in FIG. 5B, the communication 302k and the communication 302k are related to emergency PSAP services and more specifically are related to police services. Using keywords, machine learning, or some other means, the communication analysis engine 120 can analyze the communication 302k and the communication 302l and designate them as being police related emergency PSAP communications. For example, the communication analysis engine 120 can use machine learning to help classify communications 302k and 302l as police emergency PSAP communions. The communication analysis engine 120 can encapsulate the communication 302k, along with other details related to the communication 302k (e.g., as obtained using a script as a guide or other means) in a police related emergency PSAP communication 502c and encapsulate the communication 302l, along with other details related to the communication 302j (e.g., as obtained using a script as a guide or other means) in a police related emergency PSAP communication 502d.

Turning to FIG. 5C, FIG. 5C is a simplified block diagram illustrating specific example details of a system, apparatus, and method to help to enable classifying of communications to a PSAP. In an illustrative example, the communication analysis engine 120 can received communications (e.g., from the electronic device 102) and classify the communications. More specifically, the communication analysis engine 120 can receive communication 302m and communication 302n. Each of the communication 302m and the communication 302n can be a text message, audio message (e.g., voice call), or some other type of message. If the communication 302m and/or the communication 302n are an audio message, the audio message is converted to text by voice to text engine 206, illustrated in FIG. 2.

As illustrated in FIG. 5C, the communication 302m and the communication 302n are related to emergency PSAP services and more specifically are related to fire services. Using keywords, machine learning, or some other means, the communication analysis engine 120 can analyze the communication 302m and the communication 302n and designate them as being fire related emergency PSAP communications. For example, the communication analysis engine 120 can use machine learning to help classify communications 302m and 302n as fire related emergency PSAP communions. The communication analysis engine 120 can encapsulate the communication 302m, along with other details related to the communication 302m (e.g., as obtained using a script as a guide or other means) in a fire related emergency PSAP communication 502e and encapsulate the communication 302n, along with other details related to the communication 302n (e.g., as obtained using a script as a guide or other means) in a fire related emergency PSAP communication 502f.

Turning to FIG. 5D, FIG. 5D is a simplified block diagram illustrating specific example details of a system, apparatus, and method to help to enable classifying of communications to a PSAP. In an illustrative example, the communication analysis engine 120 can received communications (e.g., from the electronic device 102) and classify the communications. More specifically, the communication analysis engine 120 can receive communication 302o, communication 302p, and communication 302q. Each of the communications 302o-302q can be a text message, audio message (e.g., voice call), or some other type of message. If one or more of the communications 302o-302q are an audio message, the audio message is converted to text by voice to text engine 206, illustrated in FIG. 2.

As illustrated in FIG. 5D, the communications 302o-302q are related to non-emergency PSAP services. Using keywords, machine learning, or some other means, the communication analysis engine 120 can analyze the communications 302o-302q and designate them as being non-emergency PSAP communications. For example, the communication analysis engine 120 can use machine learning to help classify communications 302o-302q as non-emergency PSAP communions. The communication analysis engine 120 can encapsulate the communication 302o, along with other details related to the communication 302o (e.g., as obtained using a script as a guide or other means) in a non-emergency PSAP communication 502g, encapsulate the communication 302p, along with other details related to the communication 302p (e.g., as obtained using a script as a guide or other means) in a non-emergency PSAP communication 502h, and encapsulate the communication 302q, along with other details related to the communication 302q (e.g., as obtained using a script as a guide or other means) in a non-emergency PSAP communication 502i.

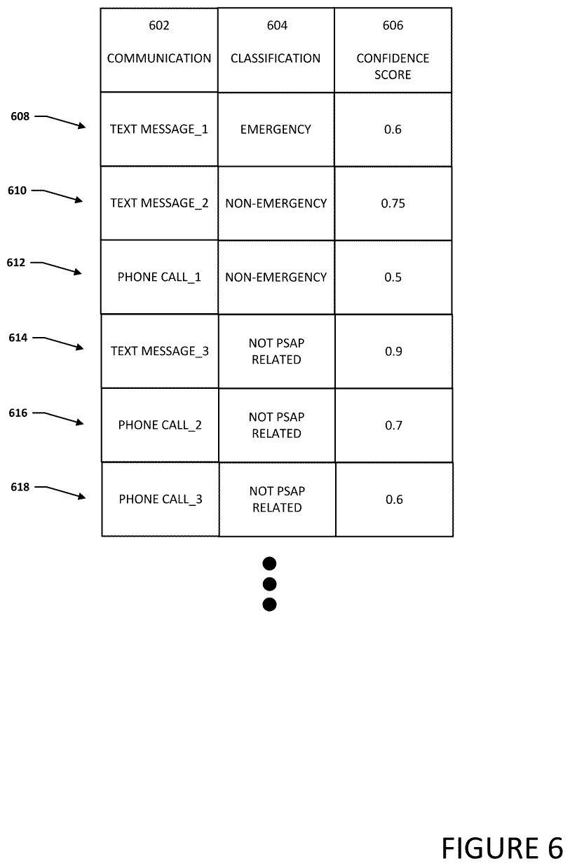

Turning to FIG. 6, FIG. 6 is a simplified block diagram illustrating specific example details of the classification of communications to help to enable classifying of communications to a PSAP. In an example, using machine learning, a classification 604 can be assigned to each communication 602 received by the communication analysis engine 120 along with a confidence score 606 regarding the classification. As illustrated in FIG. 6, the confidence score is a number between zero (0) and one (1) that represents the likelihood that the assigned classification is correct. The higher the score, the more likely the classification is correct. Note that other means can be used to indicate the likelihood that the assigned classification is correct. A human PSAP operator, the communication analysis engine 120, or some other human or computer system can analyze the confidence score and make a determine about whether or not the classification of the message should change to a different classification of the message.

In an illustrative example, as indicated by row 608, text message_1 was received by the communication analysis engine 120 and an emergency PSAP communication classification was assigned with a confidence score of 0.6. As indicated by row 610, text message_2 was received by the communication analysis engine 120 and a non-emergency PSAP communication classification was assigned with a confidence score of 0.75. As indicated by row 612, phone call_1 was received (and converted from audio to text) by the communication analysis engine 120 and a non-emergency PSAP communication classification was assigned with a confidence score of 0.5. As indicated by row 614, text message_3 was received by the communication analysis engine 120 and a not related to PSAP services classification was assigned with a confidence score of 0.9. As indicated by row 616, phone call_2 was received (and converted from audio to text) by the communication analysis engine 120 and a not related to PSAP services classification was assigned with a confidence score of 0.7. As indicated by row 618, phone call_3 was received (and converted from audio to text) by the communication analysis engine 120 and a not related to PSAP services classification was assigned with a confidence score of 0.6.

In some examples, the system can include a threshold confidence score for classifications and if a communication is assigned a classification but the confidence score is below the threshold confidence score for the classification, the communication is treated as an emergency classification to avoid missing or dropping emergency communications. More specifically, in a non-limiting illustrative example, for non-emergency classifications, the threshold confidence score may be 0.7. The text message_2 shown in row 610 was assigned the classification of a non-emergency PSAP communication with a confidence score of 0.75. Because the confidence score of 0.75 is equal to or above the threshold confidence score for the non-emergency classification, the text message_2 stays classified as a non-emergency PSAP communication. However, the phone call_1 shown in row 612 was assigned the classification of a non-emergency PSAP communication with a confidence score of 0.5. Because the confidence score of 0.5 is lower than the threshold confidence score for the non-emergency classification, the phone call_1 is changed to an emergency PSAP communication. Note that the confidence score for a non-emergency classification can be any value (e.g., any value between zero (0) and one (1)) or indicator that represents the probability of a correct classification of the communication, depending on design choice and design constraints and the threshold confidence score for the non-emergency classification should be a threshold value (e.g., a high enough value) or threshold indicator that avoids the classification of an emergency PSAP communication as a non-PSAP emergency communication.

Also, in another non-limiting illustrative example, for communications classified as a not related to PSAP services communication, the threshold confidence score may be 0.75. The text message_3 shown in row 614 was assigned the classification of not related to PSAP services communication with a confidence score of 0.9. Because the confidence score of 0.9 is above the threshold confidence score for the not related to PSAP services classification, the text message_3 stays classified as a not related to PSAP services communication. However, the phone call_2 shown in row 616 was assigned the classification of a not related to PSAP services communication with a confidence score of 0.7. Because the confidence score of 0.7 is lower than the threshold confidence score for the not related to PSAP services communication, the phone call_2 is changed to an emergency PSAP communication. Note that the confidence score for a not related to PSAP services communication can be any value (e.g., any value between zero (0) and one (1)) or indicator that represents the probability of a correct classification of the communication, depending on design choice and design constraints and, the threshold confidence score for the not related to PSAP services classification should be a threshold value (e.g., a high enough value) or threshold indicator that avoids emergency communications and non-emergency communications as being designated as a not related to PSAP services communication.

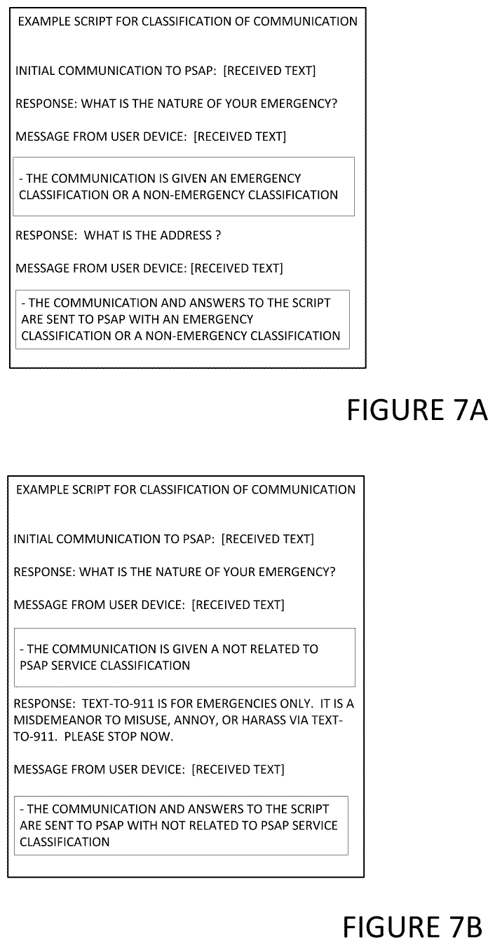

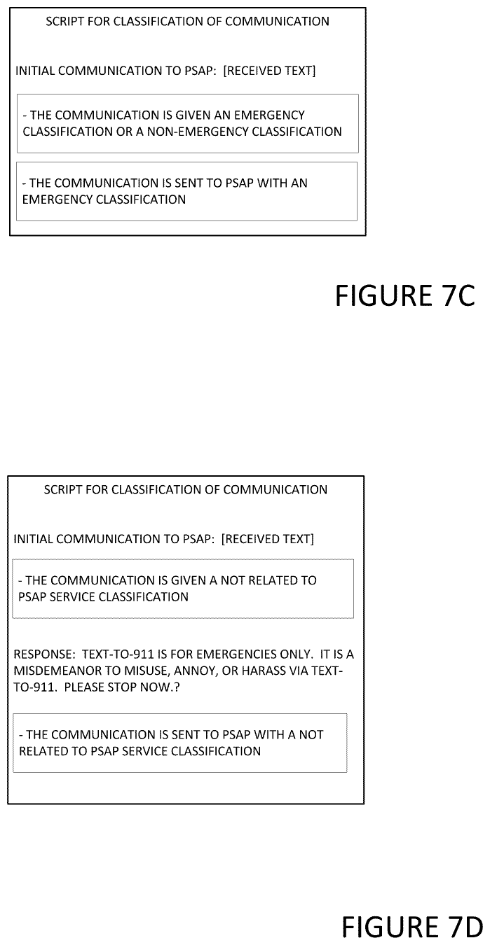

Turning to FIGS. 7A-7D, FIGS. 7A-7D illustrate a non-limiting examples of a particular implementation illustrating specific example details of scripts to help obtain additional details related to the communication to a PSAP and/or to help enable classifying of a communication to a PSAP. For example, the initial communication script 218 can be used in response to an initial communication from the electronic device 102 to help obtain additional details related to the communication to a PSAP and/or enable classifying of a communication to a PSAP. As illustrated in FIGS. 7A and 7B, using the initial communication script 218, a response to an initial communication to a PSAP can be a question that asks “What is the nature of your emergency?” Note that other responses to the initial communication to the PSAP may be used and the responses illustrated in FIGS. 7A and 7B are non-limiting examples. Based on the response from the user device to the question, the system (e.g., the communication analysis engine 120) can classify the communication as an emergency PSAP communication, a non-PSAP emergency communication, a not related to PSAP services communication, or some other type of communication. For example, the communication analysis engine 120 can use machine learning to help classify the communication as an emergency PSAP communication, a non-PSAP emergency communication, a not related to PSAP services communication, or some other type of communication.

For example, as illustrated in FIG. 7A, the communication was classified as an emergency PSAP communication (or a non-PSAP emergency communication) and a response to the question about the nature of the emergency asks for the address or location of the emergency (or non-emergency). The communication and answers or responses to the script are sent to a human operator at the PSAP with an emergency classification (or a non-emergency classification). In some examples, the communication is not classified and the communication and answers or responses to the script are sent to a human operator at the PSAP without any classification of the communication.

In another example, as illustrated in FIG. 7B, the communication was classified as a not related to PSAP services communication and a response can be given that text-to-911, if the communication was a text message, or calls to 911, if the communication was an audio message, is for emergencies only. The response can also explain that it is a misdemeanor to misuse, annoy, or harass using text-to-911 or a 911 call and give a request to stop the not related to PSAP services communication. The communication and answers or responses to the script are sent to a human operator at the PSAP with a not related to PSAP services classification. In some examples, the communication is not classified and the communication and answers or responses to the script are sent to a human operator at the PSAP without any classification of the communication. Note that the classification of the communication may be obtained through other means other than the script illustrated in FIGS. 7A and 7B.

In some examples, based on the initial communication to the PSAP, the system can obtain details related to the communication to the PSAP and/or classify the communication to a PSAP without the use of a script. For example, FIGS. 7C and 7D illustrate a non-limiting example where the initial communication to the PSAP includes enough information to enable classifying of the communication to the PSAP. As illustrated in FIGS. 7C and 7D, a response to an initial communication to a PSAP was not needed as the communication to the PSAP can be classified based on the initial communication to the PSAP. As illustrated in FIG. 7C, the initial communication to the PSAP includes enough information for the system (e.g., the communication analysis engine 120) to classify the communication as an emergency PSAP communication (or a non-PSAP emergency communication). The communication can be sent to a human operator at the PSAP with an emergency classification (or a non-emergency classification). As illustrated in FIG. 7D, the system (e.g., the communication analysis engine 120) can classify the communication as a not related to PSAP services communication. The communication is sent to a human operator at the PSAP with a not related to PSAP services classification.

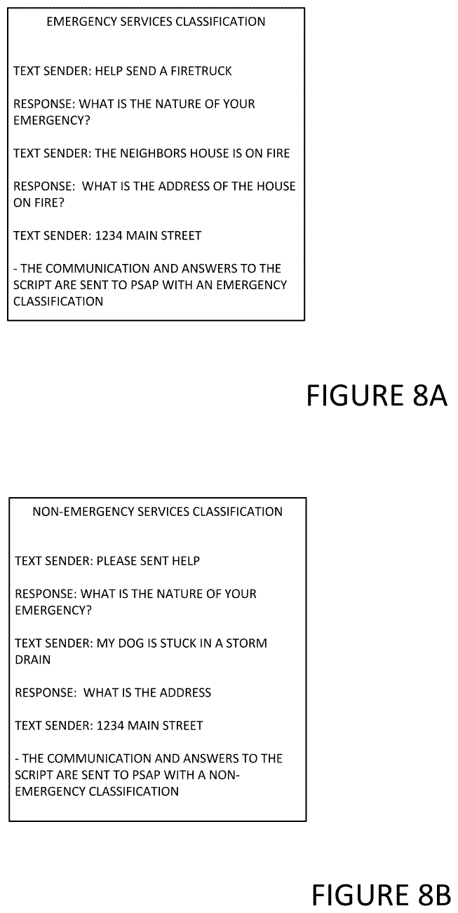

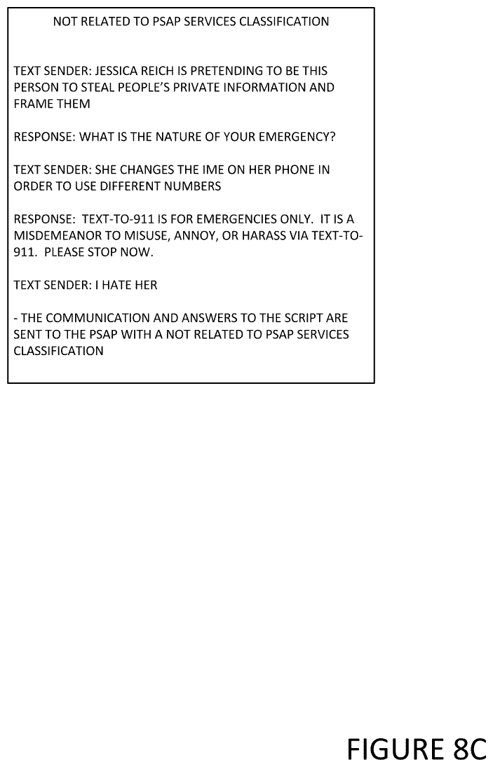

Turning to FIGS. 8A-8D, FIGS. 8A-8D are simplified block diagrams illustrating specific example details of a communication to collect information to help obtain additional details related to the communication to a PSAP and/or to help enable classifying of communications to a PSAP. For example, the initial communication script 218 can be used in response to an initial communication from the electronic device 102 to help obtain additional details related to the communication to a PSAP and/or to help enable classifying of communications to a PSAP. FIG. 8A illustrates a communication that was used to designed a communication as an emergency services communication (e.g., emergency PSAP communication 304a). As illustrated in FIG. 8A, a text message “Help send a firetruck” was received. Using the script execution engine 212 (e.g., a chat bot), the system responded with “What is the nature of your emergency?” A text message “The neighbor's house is on fire” was received. Using the script execution engine 212, the system responded with “What is the address of the house on fire?” A text message “1234 Main Street” was received. Based on the received responses to the questions from the script execution engine 212, the communication is designed as an emergency communication and the original communication (“help send a firetruck”) and the sent questions with responses are sent to the emergency PSAP communication queue 122 at the PSAP 110 where a human PSAP operator can respond to the communication. For example, the human PSAP operator can respond with the text “We are sending a firetruck to the address now” or some other response. Note also that the classification of the communication may be obtained through other means other than the script illustrated in FIG. 8A. Also note that the communication may not be classified at all and just the questions sent from the script execution engine 212 and the responses to the questions may be sent to the human operator at the PSAP.

FIG. 8B illustrates a communication that was used to designed a communication as a non-emergency services communication (e.g., similar to non-emergency PSAP communication 302c). As illustrated in FIG. 8B, a text message “Please send help” was received. Using the script execution engine 212 (e.g., a chat bot), the system responded with “What is the nature of your emergency?” A text message “My dog is stuck in a storm drain” was received. Using the script execution engine 212, the system responded with “What is the address?” A text message “1234 Main Street” was received. Based on the received responses to the questions from the script execution engine 212, the communication is designed as a non-emergency communication and the original communication (“please send help”) and the questions with received responses are sent to the non-emergency PSAP communication queue 124 at the PSAP 110 where a human PSAP operator can respond to the communication. For example, the human PSAP operator can respond with the text “We are sending a firetruck to the address now” or some other response. Note also that the classification of the communication may be obtained through other means other than the script illustrated in FIG. 8B. Also note that the communication may not be classified at all and just the questions from the script execution engine 212 and the responses to the questions may be sent to the human operator at the PSAP.

FIG. 8C illustrates a communication that was used to designed a communication as a not related to PSAP services communication (e.g., similar to non-emergency PSAP communication 302h). As illustrated in FIG. 8C, a text message “Jessica Reich is pretending to be this person to steal people's private information and frame them” was received. Using the script execution engine 212 (e.g., a chat bot), the system responded with “What is the nature of your emergency?” A text message “She changes the IME on her phone in order to use different numbers” was received. Using the script execution engine 212, the system responded with “Text-to-911 is for emergencies only. It is a misdemeanor to misuse, annoy, or harass via text-top-911. Please stop now.” A text message “I hate her” was received. Based on the received responses to the questions sent from the script execution engine 212, the communication is designed as a not related to PSAP communication and the original communication (“Jessica Reich is pretending to be this person to steal people's private information and frame them”) and the questions and received responses are sent to the not related to PSAP services communication queue 126 at the PSAP 110 where a human PSAP operator can respond to the communication. For example, the human PSAP operator can respond with the text “We are ending the session” or some other response. Note also that the classification of the communication may be obtained through other means other than the script illustrated in FIG. 8C. Also note that the communication may not be classified at all and just the questions sent from the script execution engine 212 and the responses to the questions may be sent to the human operator at the PSAP.

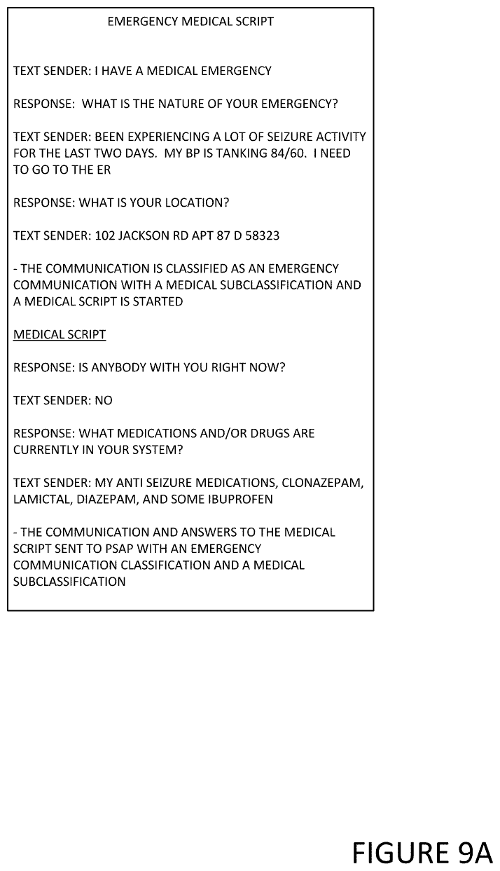

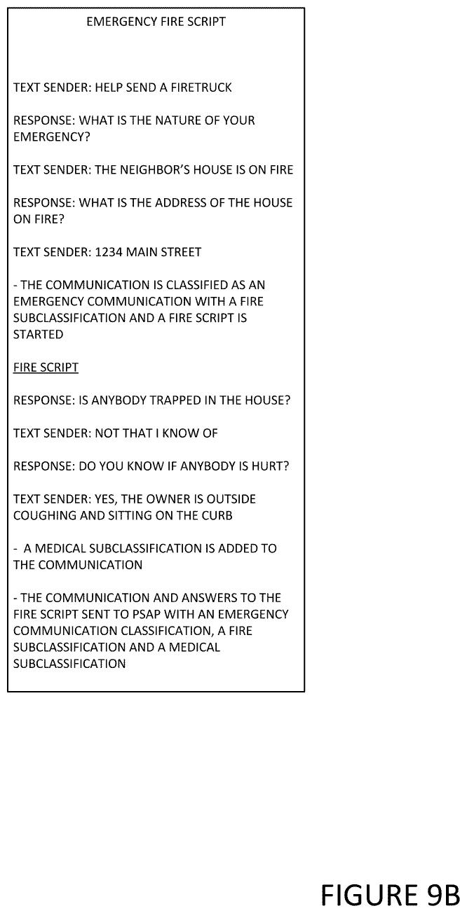

FIG. 9A illustrates a communication that was used to designed a communication as a medical related emergency PSAP services communication (e.g., similar to the medical related emergency PSAP communication 502a) and the use of a medical emergency script as a guide to help collect additional information related to the communication to the PSAP. As illustrated in FIG. 9A, a text message “I have a medical emergency” was received. Using the script execution engine 212 (e.g., a chat bot), the system responded with “What is the nature of your emergency?” A text message “Been experiencing a lot of seizure activity for the last two days. My BP is tanking 84/60. I need to go to the ER.” was received. Using the script execution engine 212, the system responded with “What is your location?” A text message “102 Jackson Rd. Apt 87 D58323” was received. Based on the responses to the questions sent from the script execution engine 212, the system classified the communication as an emergency communication with a medical emergency subclassification and a medical script (e.g., the medical emergency script 224) was started to collect more information about the medical emergency.

Using the script execution engine 212, the system responded with “Is anybody with you right now?” A text message, “No” was received. Using the script execution engine 212, the system responded with “What medication and/or drugs are currently in your system?” A text message, “My antiseizure medications, clonazepam, lamictal, diazepam, and some ibuprofen” was received. The original communication (“I have a medical emergency”), the emergency classification with a medical emergency subclassification, and the questions and responses are sent to the emergency PSAP communication queue 122 at the PSAP 110 where a human PSAP operator can respond to the communication. For example, the human PSAP operator can respond with the text “We are sending an ambulance to the address now. Please stay on the line.” or some other response. Note also that the classification of the communication may be obtained through other means other than the script illustrated in FIG. 9A. Also note that the communication may not be classified at all and just the questions sent from the script execution engine 212 and the responses to the questions may be sent to the human operator at the PSAP.

FIG. 9B illustrates a communication that was used to designed a communication as a fire related emergency PSAP services communication and the use of a fire emergency script as a guide to help collect additional information related to the communication to the PSAP. As illustrated in FIG. 7B, a text message “Help send a firetruck” was received. Using the script execution engine 212 (e.g., a chatbot), the system responded with “What is the nature of your emergency?” A text message “The neighbor's house is one fire.” was received. Using the script execution engine 212, the system responded with “What is the address of the house on fire?” A text message “1234 Main Street” was received. The system classified the communication as an emergency communication with a fire subclassification and a fire script (e.g., the fire emergency script 220) was started to collect more information about the fire emergency.

Using the script execution engine 212, the system responded with “Is anybody trapped in the house?” A text message “Not that I know of” was received. Using the script execution engine 212, the system responded with “Do you know if anybody is hurt?” A text message “Yes, the owner is outside coughing and sitting on the curb” was received. A medical subclassification is added to the communication. Based on the responses to the questions sent from the script execution engine 212, the communication is designed as an emergency communication with a fire subclassification and a medical subclassification. The original communication (“Help send a firetruck”), the emergency classification with a fire emergency subclassification and a medical emergency subclassification, and the questions with responses are sent to the emergency PSAP communication queue 122 at the PSAP 110 where a human PSAP operator can respond to the communication. For example, the human PSAP operator can respond with the text “We are sending a firetruck to the address now. Please stay on the line.” or some other response. Note also that the classification of the communication may be obtained through other means other than the script illustrated in FIG. 9B. Also note that the communication may not be classified at all and just the questions sent from the script execution engine 212 and the responses to the questions may be sent to the human operator at the PSAP.

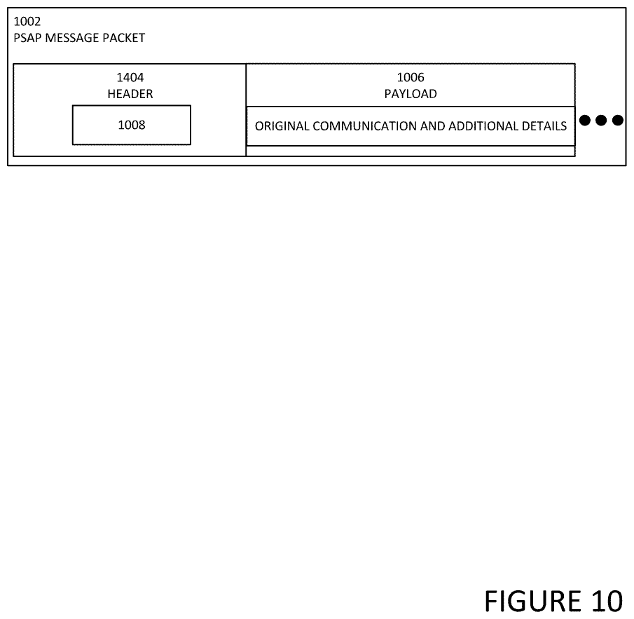

Turning to FIG. 10, FIG. 10 is a simplified block diagram illustrating specific non-limiting example details of a packet that may be used as part of a system to enable classifying of communications to a PSAP. In an illustrative example, after intercepting the communication to the PSAP 110 and classifying the communication, the communication analysis engine 120 can send a PSAP packet 1002 to the PSAP 110. The PSAP packet 1002 can include a header portion 1004 and a payload portion 1006. The header portion can include a flag 1008 or some other indicator of the classification of the communication to the PSAP. For example, the flag 1008 can indicate if the communication is an emergency communication, a non-emergency communication, or a not related to PSAP services communication. In some examples, the flag 1008, or a different flag or flags, can indicate if the communication is one or more of a medical emergency communication, a fire emergency communication, a police emergency communication, etc. The payload portion 1006 can include the original communication to the PSAP and any additional details related to the original communication (e.g., answers to questions from a script or other information that may help a human PSAP operator).

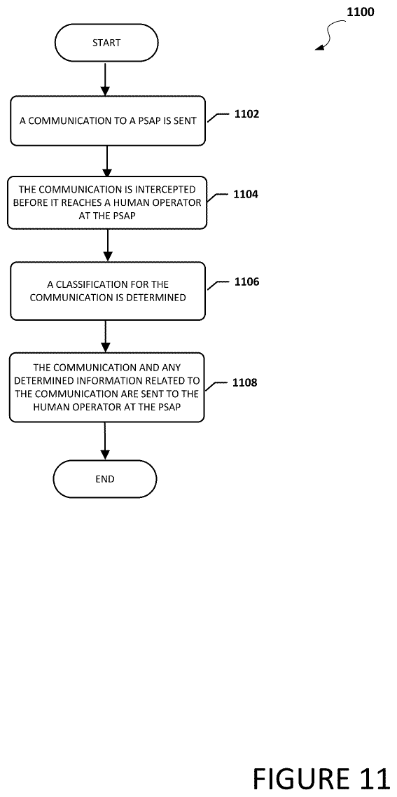

Turning to FIG. 11, FIG. 11 is example flowchart illustrating possible operations of a flow 1100 that may be associated with potential operations to help enable classifying of communications to a PSAP, in accordance with an embodiment of the present disclosure. Specifically, in some examples, one or more operations of flow 1100 may be performed by the electronic device 102, the PSAP 110, the communication analysis engine 120, the voice to text engine 206, the translation engine 208, the classification engine 210, the script execution engine 212, and/or the PSAP forwarding engine 214. At 1102, a communication to a PSAP is sent. For example, the electronic device 102 can send the PSAP 110 a text message, a voice call, an audio message, or some other type of message. At 1104, the communication is intercepted before it reaches a human operator at the PSAP. For example, the communication analysis engine 120 located in the server 104, cloud services 106, network element 108, or the PSAP 110a can intercept the communication before it reaches a human operator at the PSAP.

At 1106, a classification for the communication is determined. For example, the classification engine 210 in the communication analysis engine 120 can assign a classification to the communication. In some examples, an AI chat bot can be used to gather additional information about the circumstances related to the communication and the classification engine 210 can use the additional information to assign a classification to the communication. In other examples, a linear type script may be used as a guide to gather additional information about the circumstances related to the communication. In some examples, metadata related to the communication can be analyzed to determine additional information related to the communication. Also, if possible, in some examples, the electronic device that originated the communication (e.g., the camera of the electronic device, the microphone of the electronic device, the GPS of the electronic device, etc.) and/or one or more other electronic devices (e.g., wearables, security cameras, detectors, etc.) in the area of the electronic device that originated the communication can be used to determine additional information related to the communication.

At 1108, the communication and any determined additional information related to the communication (e.g., answers to questions from a script) are sent to the human operator at the PSAP. For example, if the communication is classified by the communication analysis engine 120 as an emergency PSAP communication, the communication is sent to a human PSAP operator at the emergency PSAP communication queue 122, if the communication is classified by the communication analysis engine 120 as a non-emergency PSAP communication, the communication is sent to a human PSAP operator at the non-emergency PSAP communication queue 124, and if the communication is classified by the communication analysis engine 120 as not related to PSAP services (e.g., accidental communications, prank communications, spam, etc.) the communication is sent to a human PSAP operator at the not related to PSAP services communication queue 126. By classifying emergency PSAP communications, non-emergency PSAP communications, and not related to PSAP communications from the electronic device 102 to the PSAP 110, the communication analysis engine 120 can triage the communications and allow an emergency service operator to focus their attention on the emergency PSAP communications.

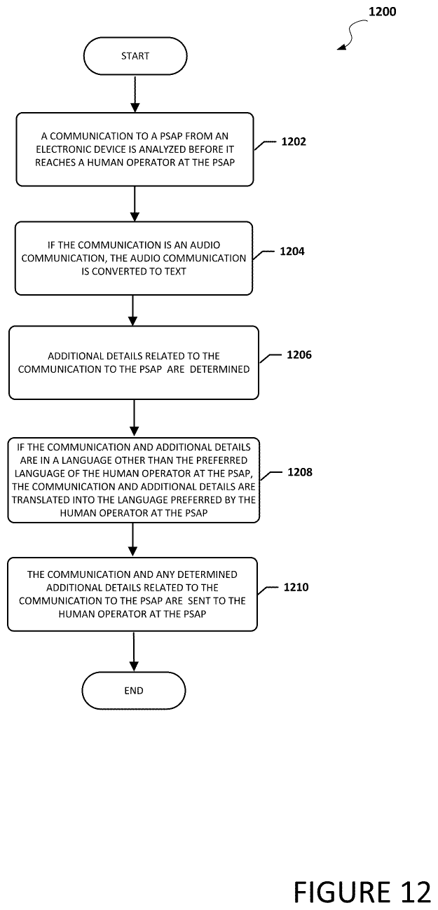

Turning to FIG. 12, FIG. 12 is example flowchart illustrating possible operations of a flow 1200 that may be associated with potential operations to help enable obtaining additional information, in accordance with an embodiment of the present disclosure. Specifically, in some examples, one or more operations of flow 1200 may be performed by the electronic device 102, the PSAP 110, the communication analysis engine 120, the voice to text engine 206, the translation engine 208, the classification engine 210, the script execution engine 212, and/or the PSAP forwarding engine 214. At 1202, a communication to a PSAP from an electronic device is analyzed before it reaches a human operator at the PSAP. For example, the electronic device 102 can send the PSAP 110 a text message, a voice call, an audio message, or some other type of message and the communication analysis engine 120 located in the server 104, cloud services 106, network element 108, or the PSAP 110a can intercept and analyze the communication before it reaches a human operator at the PSAP.

At 1204, if the communication is an audio communication, the audio communication is converted to text. For example, if the communication is a voice call or audio message, the voice to text engine 206 in the communication analysis engine 120 can convert the voice call or audio message to text. At 1206, additional details related to the communication to the PSAP are determined. For example, the script execution engine 212 (e.g., a chatbot) can be used to engage in a chart or dialogue with a user related to the commutation, where the chat or dialogue is based on a script from the scripts database 216 and through the chat or dialogue, the user can be prompted to provide additional details related to the communication to the PSAP. Also, metadata related to the communication can be analyzed to determine additional details related to the communication to the PSAP. In addition, the electronic device 102 (e.g., the camera of the electronic device 102, the microphone of the electronic device 102, the GPS of the electronic device 102, etc.) and/or one or more other electronic devices (e.g., wearables, security cameras, detectors, etc.) in the area of the electronic device 102 that originated the communication can be used to determine additional details related to the communication to the PSAP.

At 1208, if the communication and additional details are in a language other than the preferred language of the human operator at the PSAP, the communication and additional details are translated into the language preferred by the human operator at the PSAP. For example, if the preferred language of the human PSAP operator is English, then the translation engine 208 will convert the communication and additional details into English. At 1210, the communication and additional details related to the communication to the PSAP are sent to the human operator at the PSAP. For example, the PSAP forwarding engine 214 located in the communication analysis engine 120 can send the communication and additional details related to the communication to the human operator at the PSAP.

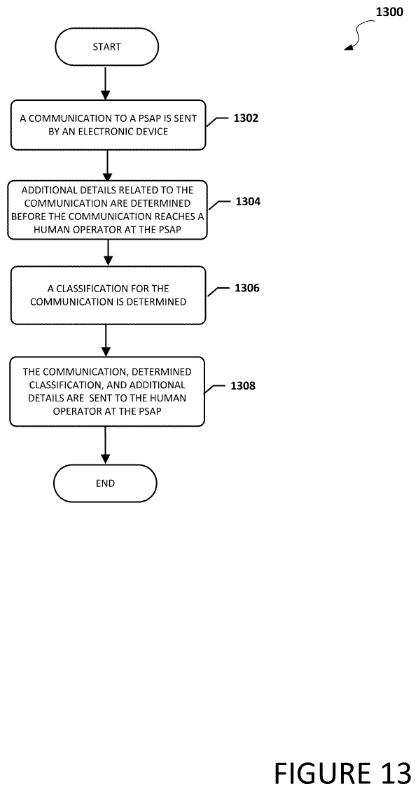

Turning to FIG. 13, FIG. 13 is example flowchart illustrating possible operations of a flow 1300 that may be associated with potential operations to help enable classifying of communications to a PSAP, in accordance with an embodiment of the present disclosure. Specifically, in some examples, one or more operations of flow 1300 may be performed by the electronic device 102, the PSAP 110, the communication analysis engine 120, the voice to text engine 206, the translation engine 208, the classification engine 210, the script execution engine 212, and/or the PSAP forwarding engine 214. At 1302, a communication to a PSAP is sent by an electronic device. For example, the electronic device 102 can send the PSAP 110 a text message, a voice call, an audio message, or some other type of message.

At 1304, additional details related to the communication are determined before the communication reaches a human operator at the PSAP. For example, the communication analysis engine 120 located in the server 104, cloud services 106, network element 108, or the PSAP 110a can intercept the communication before it reaches a human operator at the PSAP and use a script as a guide to engage in a chart or dialogue with a user of the electronic device 102 to determine additional details about the communication before the communication is sent to the PSAP 110. At 1306, a classification for the communication is determined. For example, based on the original communication and/or the determined additional information, the communication can be classified as an emergency PSAP communication, a non-emergency PSAP communication, or a not related to PSAP services communication. At 1308, the communication, determined classification, and additional information are sent to the human operator at the PSAP. For example, the PSAP forwarding engine 214 located in the communication analysis engine 120 can send the communication, determined classification, and the additional information to the human operator at the PSAP.

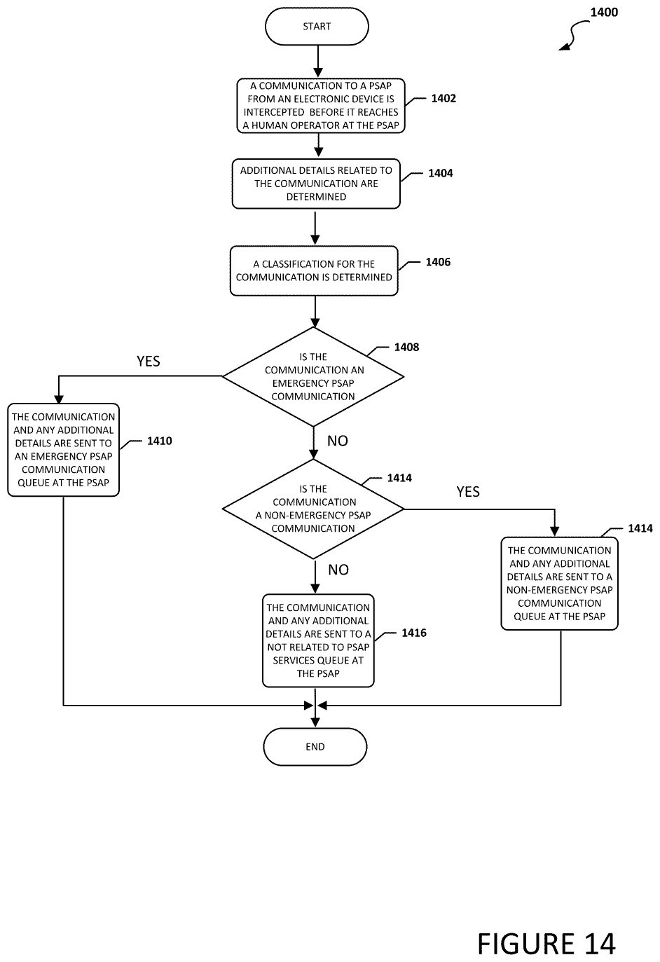

Turning to FIG. 14, FIG. 14 is example flowchart illustrating possible operations of a flow 1400 that may be associated with potential operations to help enable classifying of communications to a PSAP, in accordance with an embodiment of the present disclosure. In some examples, one or more operations of flow 1400 may be performed by the electronic device 102, the PSAP 110, the communication analysis engine 120, the voice to text engine 206, the translation engine 208, the classification engine 210, the script execution engine 212, and/or the PSAP forwarding engine 214. At 1402, a communication to a PSAP from an electronic device is intercepted before it reaches a human operator at the PSAP. For example, the electronic device 102 can send the PSAP 110 a text message, a voice call, an audio message, or some other type of message and the communication analysis engine 120 located in the server 104, cloud services 106, network element 108, or the PSAP 110a can intercept the communication before it reaches a human operator at the PSAP.

At 1404, additional details related to the communication are determined. For example, the communication analysis engine 120 can intercept the communication before it reaches a human operator at the PSAP and use a communication classification script 218 to obtain additional information and details related to the communication. At 1406, a classification for the communication is determined. For example, based on the original communication and/or the obtained additional information and details (e.g., from responses to a chat or dialog from a chatbot), the classification engine 210 can classify the communication as an emergency PSAP communication, a non-emergency PSAP communication, or a not related to PSAP services communication.

At 1408, the system determines if the communication is an emergency PSAP communication. If the communication is an emergency PSAP communication, the communication and any additional information and details related to the communication are sent to an emergency PSAP communication queue at the PSAP, as in 1410. For example, if the communication is classified as an emergency PSAP classification, then the communication and any additional information and details related to the communication are sent to the emergency PSAP communication queue 122 at the PSAP 110. If the communication is not classified as an emergency PSAP communication, the system determines if the communication is classified as a non-emergency PSAP communication, as in 1412. If the communication is classified as a non-emergency PSAP communication, the communication and any additional information and details related to the communication are sent to a non-emergency PSAP communication queue at the PSAP, as in 1414. For example, if the communication is classified as a non-emergency PSAP classification, then the communication and any additional information and details related to the communication are sent to the non-emergency PSAP communication queue 124 at the PSAP 110. If the communication is not classified as a non-emergency classification, then the communication and any additional information and details associated with the classification are sent to a not-related to PSAP services queue at the PSAP, as in 1416. For example, if the communication is classified as not related to PSAP services, then the communication and any additional information and details related to the communication are sent to the not related to PSAP services communication queue 126 at the PSAP 110.

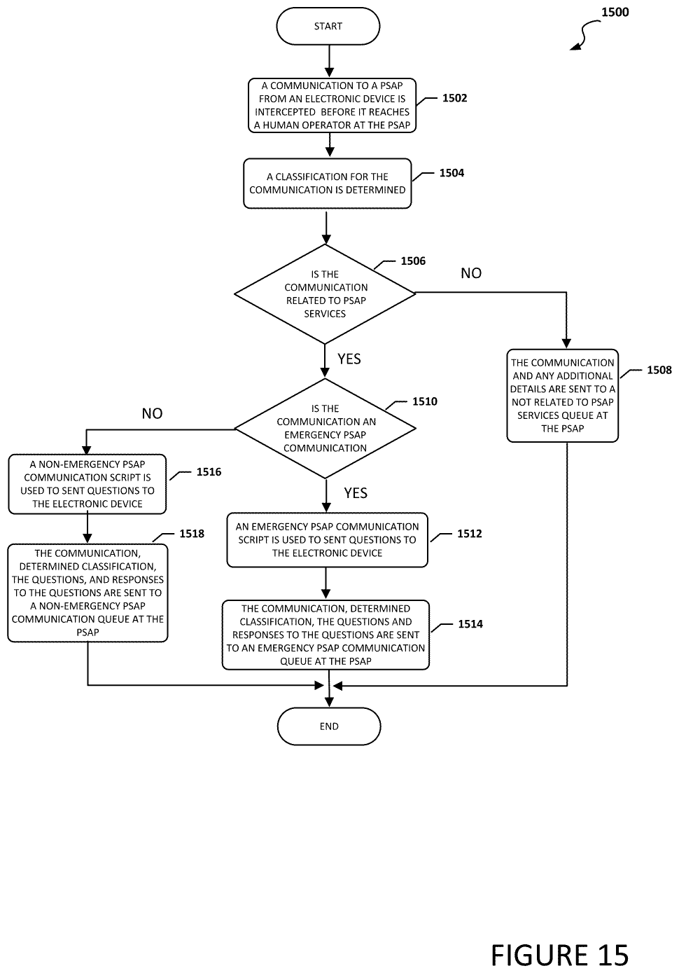

Turning to FIG. 15, FIG. 15 is example flowchart illustrating possible operations of a flow 1500 that may be associated with potential operations to classify communications and obtain additional details to help enable classifying of communications to a PSAP, in accordance with an embodiment of the present disclosure. In some examples, one or more operations of flow 1500 may be performed by the electronic device 102, the PSAP 110, the communication analysis engine 120, the voice to text engine 206, the translation engine 208, the classification engine 210, the script execution engine 212, and/or the PSAP forwarding engine 214. At 1502, a communication to a PSAP from an electronic device is intercepted before it reaches a human operator at the PSAP. For example, the electronic device 102 can send the PSAP 110 a text message, a voice call, an audio message, or some other type of message and the communication analysis engine 120 located in the server 104, cloud services 106, network element 108, or the PSAP 110a can intercept the communication before it reaches a human operator at the PSAP.

At 1504, a classification for the communication is determined. For example, the communication analysis engine 120 can intercept the communication before it reaches a human operator at the PSAP and determine a classification for the communication. At 1506, the system determines if the communication is related to PSAP services. For example, the communication analysis engine 120 can assign an emergency PSAP classification to the communication, a non-emergency PSAP classification to the communication, or a not related to PSAP services classification to the communication. If the system determines the communication is not related to PSAP services, the communication and any additional details related to the communication are sent to a not related to PAP service queue at the PSAP, as in 1508. For example, if the system determines that the communication is not related to PSAP services, then the communication and any additional details related to the communication are sent to the not related to PSAP services communication queue 126 at the PSAP 110.

If the communication is related to PSAP services, then the system determines if the communication is an emergency PSAP communication, as in 1510. If the communication is classified as an emergency PSAP communication, then an emergency PSAP communication script is used as a guide to send questions to the electronic device, as in 1512. For example, the script execution engine 212 (e.g., a chatbot) can use an emergency PSAP communication script from the script database 216 as a guide to send one or more questions to the electronic device 102 and a user of the electronic device 102 can be prompted to provide additional details related to the communication. At 1514, the communication, determined classification, the questions, and the response or responses to the questions are sent to an emergency PSAP communication queue at the PSAP. For example, the PSAP forwarding engine 214 located in the communication analysis engine 120 can send the communication, determined classification, the one or more questions, and the response or responses to the questions to the emergency PSAP communication queue 122 at the PSAP 110.

Going back to 1510, if the communication is not an emergency PSAP communication, then a non-emergency PSAP communication script is used to send questions to the electronic device, as in 1516. For example, the script execution engine 212 can use a non-emergency PSAP communication script from the scripts database 216 as a guide to send questions to the electronic device 102 and a user of the electronic device 102 can be prompted to provide additional details related to the communication to the PSAP. At 1518, the communication, determined classification, the questions, and the response or responses to the questions are sent to a non-emergency PSAP communication queue at the PSAP. For example, the PSAP forwarding engine 214 located in the communication analysis engine 120 can send the communication, determined classification, the one or more questions, and the response or responses to the questions to the non-emergency PSAP communication queue 124 at the PSAP 110.

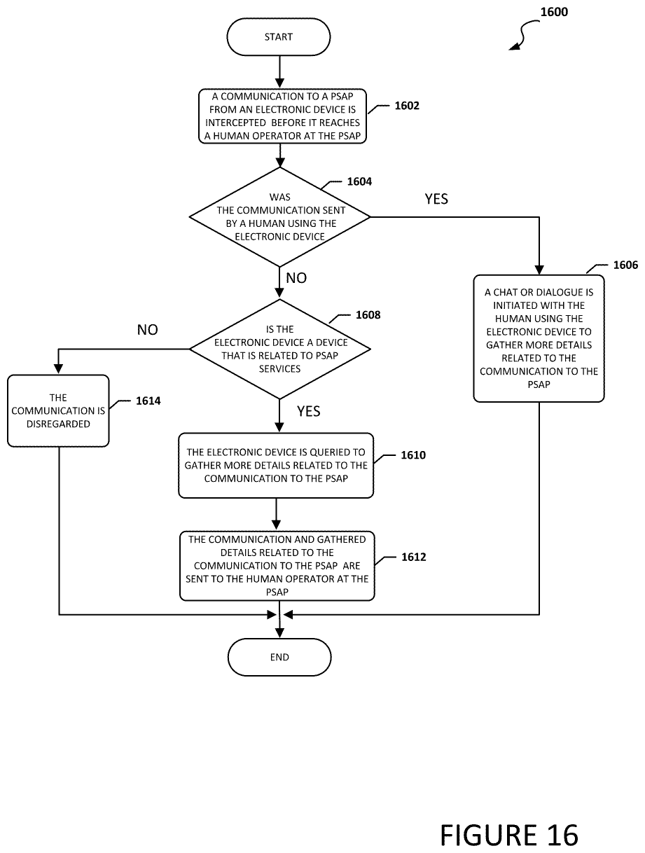

Turning to FIG. 16, FIG. 16 is example flowchart illustrating possible operations of a flow 1600 that may be associated with potential operations to gather information or details to help enable classifying of communications to a PSAP, in accordance with an embodiment of the present disclosure. In some examples, one or more operations of flow 1600 may be performed by the electronic device 102, the PSAP 110, the communication analysis engine 120, the voice to text engine 206, the translation engine 208, the classification engine 210, the script execution engine 212, and/or the PSAP forwarding engine 214. At 1602, a communication to a PSAP from an electronic device is intercepted before it reaches a human operator at the PSAP. For example, the electronic device 102 can send the PSAP 110 a text message, a voice call, an audio message, or some other type of message and the communication analysis engine 120 located in the server 104, cloud services 106, network element 108, or the PSAP 110a can intercept the communication before it reaches a human operator at the PSAP.

At 1604, the system determines if the communication was sent by a human using the electronic device. For example, the system can use a prompt (e.g., press “1” to continue, etc.) or some other means to determine if the communication was sent by a human using the electronic device. If the communication was sent by a human using the electronic device, a chat or dialogue is initiated with the human using the electronic device to gather more details related to the communication to the PSAP, as in 1606. For example, the script execution engine 212 can be used to send questions from a script in the scripts database 216 to the electronic device 102 and the user (human) of the electronic device 102 can be prompted to provide additional details related to the communication to the PSAP.

If the system determines that the communication was not sent by a human, the system determines if the electronic device is a device that is related to PSAP services, as in 1608. For example, the system can determine if the electronic device that sent the communication is an IoT device such as a flood detector, security camera, security alarm, smoke detector, carbon monoxide detector, or some other device that is related to PSAP services. If the electronic device that sent the communication is a device that is related to PSAP services, the electronic device is queried to gather more details related to the communication to the PSAP, as in 1610. For example, the device can be queried about its location to try and determine the location of the cause for the communication to the PSAP. In some examples, it can be difficult or unnecessary to query the electronic device to gather more details related to the communication to the PSAP and the system may be unable to query the electronic device, not need to query the electronic device, or the electronic device may not respond to the query. At 1612, the communication and gathered details (if any) related to the communication to the PSAP are send to the human operator at the PSAP. For example, the PSAP forwarding engine 214 located in the communication analysis engine 120 can send the communication and any gathered details related to the communication to the PSAP to the human operator at the PSAP. Going back to 1608, if the electronic device that sent the communication is not a device that is related to PSAP services, for example, a known spam messaging center, the communication is disregarded, as in 1614.

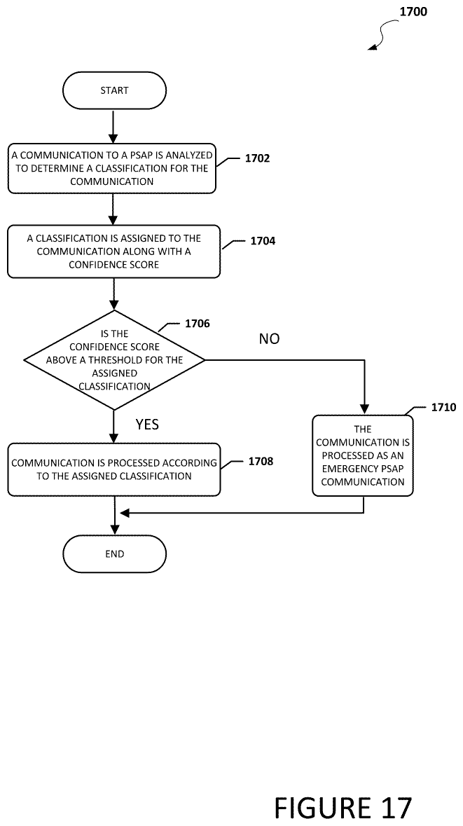

Turning to FIG. 17, FIG. 17 is example flowchart illustrating possible operations of a flow 1700 that may be associated with potential operations of using a confidence score to help enable classifying of communications to a PSAP, in accordance with an embodiment of the present disclosure. some examples, one or more operations of flow 1700 may be performed by the electronic device 102, the PSAP 110, the communication analysis engine 120, the voice to text engine 206, the translation engine 208, the classification engine 210, the script execution engine 212, and/or the PSAP forwarding engine 214. At 1702, a communication to a PSAP is analyzed to determine a classification for the communication. For example, the classification engine 210 in the communication analysis engine 120 can analyze the communication and any additional acquired details related to the communication to determine a classification for the communication. At 1704, a classification is assigned to the communication along with a confidence score. For example, the classification engine 210 in the communication analysis engine 120 can assign an emergency PSAP classification and a confidence score for the classification, a non-emergency PSAP classification and a confidence score for the classification, or a not related to PSAP services classification and a confidence score for the classification. At 1706, the system determines if the confidence score is above a threshold for the assigned classification. For example, for non-emergency classifications, the threshold confidence score may be 0.7 and for communications classified as a not related to PSAP services, the threshold confidence score may be 0.9. If the confidence score is above a threshold for the classification, the communication is processed according to the assigned classification, as in 1708. For example, if the communication was assigned a not related to PSAP services classification and the confidence score was above the threshold confidence score of 0.9, then the communication can be sent to a human operator at a not related to PSAP services communication queue or low priority queue at the PSAP (e.g., a not related to PSAP services communication queue 126). If the confidence score is not above a threshold for the classification, then the communication is processed as an emergency PSAP communication, as in 1710. For example, if the communication was assigned a non-emergency PSAP classification and the confidence score was below the threshold confidence score of 0.6, then the communication is re-classified (e.g., by a human, especially a PSAP operator, or by the system) as an emergency PSAP classification. If the communication is classified as an emergency classification, the classification is kept as an emergency classification, regardless of the confidence score, to avoid misclassifying emergency communications. Note that the confidence score for each classification can be any value (e.g., any value between zero (0) and one (1)) or indicator that represents the probability of a correct classification of the communication, depending on design choice and design constraints. However, the threshold value for a not related to PSAP services classification should be high enough to avoid emergency communications and non-emergency communications being sent to the lowest priority queue. Also, the threshold value for a non-emergency PSAP classification should be high enough to avoid the classification of an emergency PSAP communication as a non-PSAP emergency communication. In some examples, a human (e.g., a human PSAP operator) makes the decision about the confidence score and whether or not the confidence score is high enough to avoid re-classification of the communication. In other examples, the system makes the decision about the confidence score and whether or not the confidence score is high enough to avoid re-classification of the communication.

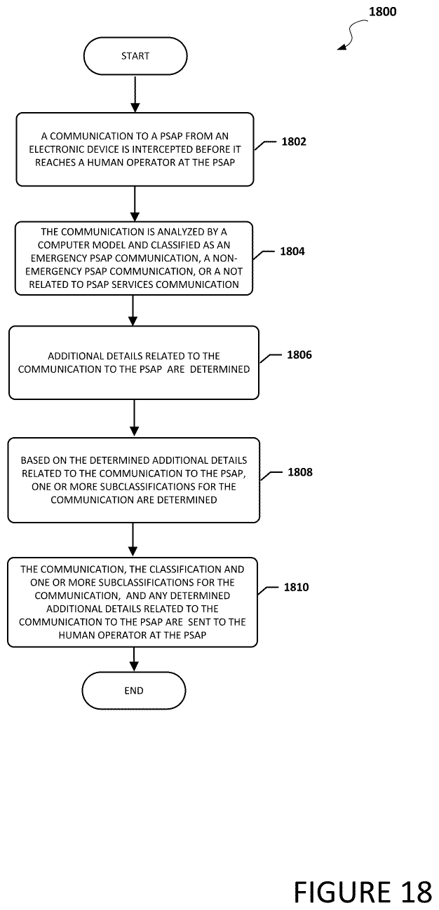

Turning to FIG. 18, FIG. 18 is example flowchart illustrating possible operations of a flow 1800 that may be associated with potential operations to help enable classifying of communications to a PSAP, in accordance with an embodiment of the present disclosure. In some examples, one or more operations of flow 1800 may be performed by the electronic device 102, the PSAP 110, the communication analysis engine 120, the voice to text engine 206, the translation engine 208, the classification engine 210, the script execution engine 212, and/or the PSAP forwarding engine 214. At 1802, a communication to a PSAP from an electronic device is intercepted before it reaches a human operator at the PSAP. For example, the electronic device 102 can send the PSAP 110 a text message, a voice call, an audio message, or some other type of message and the communication analysis engine 120 located in the server 104, cloud services 106, network element 108, or the PSAP 110a can intercept and analyze the communication before it reaches a human operator at the PSAP.

At 1804, the communication is analyzed by a computer model and classified as an emergency PSAP communication, a non-emergency PSAP communication, or a not related to PSAP services communication. For example, the classification engine 210 can classify the communication as an emergency PSAP communication, a non-emergency PSAP communication, or a not related to PSAP services communication. At 1806, additional details related to the communication to the PSAP are determined. For example, the script execution engine 212 can use a script from the scripts database 216 as a guide to send questions to the electronic device 102 and a user of the electronic device 102 can be prompted to provide additional details related to the communication to the PSAP. In another example, metadata related to the communication can be analyzed to determine additional details related to the communication to the PSAP (e.g., location of the electronic device 102, a user associated with the electronic device 102, etc.). In some examples, the electronic device 102 can be used (e.g., the camera of the electronic device 102, the microphone of the electronic device 102, the GPS of the electronic device 102, etc.) and/or one or more other electronic devices (e.g., wearables, security cameras, detectors, etc.) in the area of the electronic device 102 can be used to determine additional details related to the communication to the PSAP.

At 1808, based on the determined additional details related to the communication to the PSAP, one or more subclassifications for the communication are determined. For example, the classification engine 210 can subclassify the communication as a fire emergency PSAP communication, a medical emergency PSAP communication, a crime related emergency PSAP communication, or some other subclassification. In some examples, non-emergency classified communications are subclassified by the type of response that may be needed or appropriate for the non-emergency classification. For example, a fire non-emergency subclassification may be used for a communication to rescue a dog stuck in a storm drain or a police non-emergency subclassification may be used for a loud noise complaint communication.

At 1810, the communication, the classification and the one or more subclassifications for the communication, and any determined additional details related to the communication to the PSAP are sent to the human operator at the PSAP. For example, the PSAP forwarding engine 214 located in the communication analysis engine 120 can send the communication, the classification, the one or more subclassifications for the communication, and any determined additional details related to the communication to the PSAP to the human operator at the PSAP.

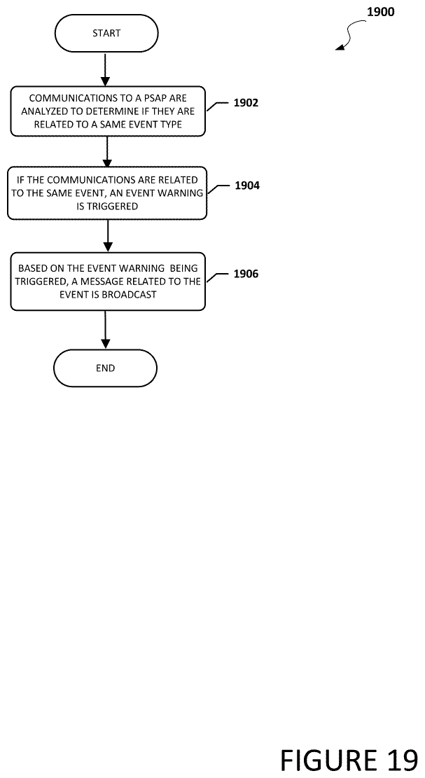

Turning to FIG. 19, FIG. 19 is example flowchart illustrating possible operations of a flow 1900 that may be associated with potential operations to identify and event and trigger an event warning, in accordance with an embodiment of the present disclosure. In some examples, one or more operations of flow 1900 may be performed by the electronic device 102, the PSAP 110, the communication analysis engine 120, the voice to text engine 206, the translation engine 208, the classification engine 210, the script execution engine 212, and/or the PSAP forwarding engine 214. At 1902, communications to a PSAP are analyzed to determine if they are related to a same event. For example, communications to the PSAP 110 can be analyzed by the communication analysis engine 120 to determine if they are related to the same event (e.g., an earthquake, flood, pandemic outbreak, etc.). At 1904, if the communications are related to the same event, an event warning is triggered. For example, if the communications are related to the same event, the local and/or the federal government can be alerted to the event. At 1906, based on the event warning being triggered, a message related to the event is broadcast. For example, if the event is an earthquake, instructions about what to do in an earthquake and/or what to do after an earthquake can be broadcast to the public in the areas affect by the earthquake.

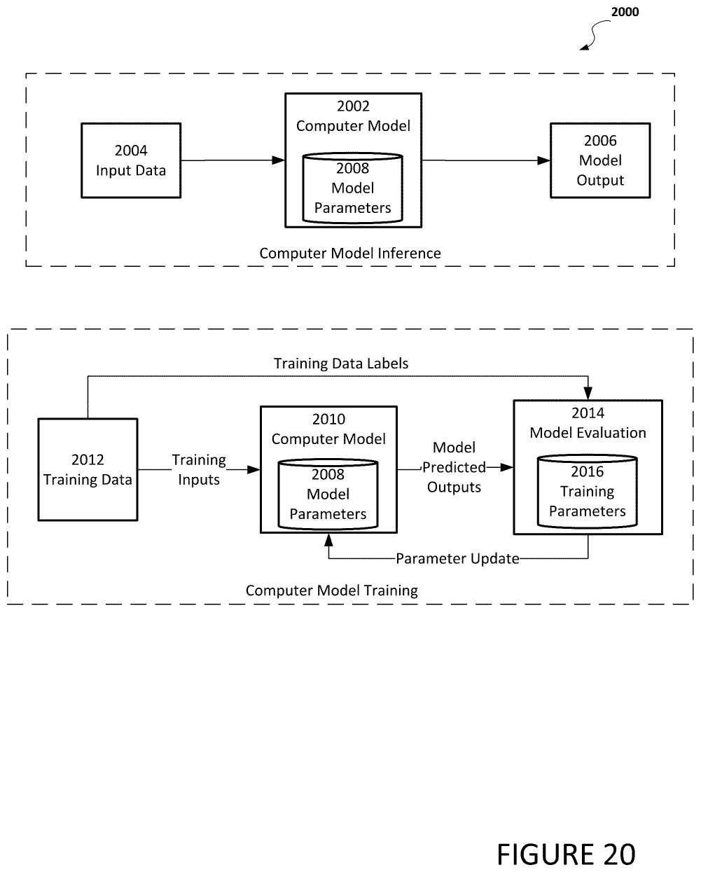

Turning to FIG. 20, FIG. 20 illustrates example computer model inference and computer model training 2000. Computer model inference refers to the application of a computer model 2002 to a set of input data 2004 to generate an output or model output 2006. The computer model 2002 determines the model output 2006 based on parameters of the model, also referred to as model parameters 2008. The parameters of the model may be determined based on a training process that finds an optimization of the model parameters 2008, typically using training data and desired outputs of the model for the respective training data as discussed below. The output (e.g., the classification of communications to a PSAP) of the computer model 2002 may be referred to as an “inference” because it is a predictive value based on the input data 2004 and based on previous example data used in the model training.

The input data 2004 and the model output 2006 vary according to the particular use case. For example, to determine a classification of communications to a PSAP analysis, the input data 2004 may be a text or audio communication and the output or “inference” may be a classification of the communication. For computer vision and image analysis, the input data 2004 may be an image having a particular resolution, such as 75×75 pixels, or a point cloud describing a volume. In other applications, the input data 2004 may include a vector, such as a sparse vector, representing information about an object. For example, in recommendation systems, such a vector may represent user-object interactions, such that the sparse vector indicates individual items positively rated by a user. In addition, the input data 2004 may be a processed version of another type of input object, for example representing various features of the input object or representing preprocessing of the input object before input of the object to the computer model 2002. As one example, a 1024×1024 resolution image may be processed and subdivided into individual image portions of 64×64, which are the input data 2004 processed by the computer model 2002. As another example, the input object, such as a sparse vector discussed above, may be processed to determine an embedding or another compact representation of the input object that may be used to represent the object as the input data 2004 in the computer model 2002. Such additional processing for input objects may themselves be learned representations of data, such that another computer model processes the input objects to generate an output that is used as the input data 2004 for the computer model 2002. Although not further discussed here, such further computer models may be independently or jointly trained with the computer model 2002. As noted above, the model output 2006 may depend on the particular application of the computer model 2002, for example, classifying communications to a PSAP.

The computer model 2002 includes various model parameters 2008, as noted above, that describe the characteristics and functions that generate the model output 2006 from the input data 2004. In particular, the model parameters 2008 may include a model structure, model weights, and a model execution environment. The model structure may include, for example, the particular type of computer model 2002 and its structure and organization. For example, the model structure may designate a neural network, which may be comprised of multiple layers, and the model parameters 2008 may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 2002 processes the input data 2004 to the model output 2006. Each portion or layer of the computer model 2002 may have such weights. For example, weights may be used to determine values for processing inputs to determine outputs at a particular portion of a model. Stated another way, for example, model weights may describe how to combine or manipulate values of the input data 2004 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer.

The model execution parameters represent parameters describing the execution conditions for the model. In particular, aspects of the model may be implemented on various types of hardware or circuitry for executing the computer model 2002. For example, portions of the model may be implemented in various types of circuitry, such as general-purpose circuitry (e.g., a general CPU), circuitry specialized for certain functions (e.g., a GPU or programmable Multiply-and-Accumulate circuit) or circuitry specially designed for the particular computer model application. In some configurations, different portions of the computer model 2002 may be implemented on different types of circuitries. As discussed below, training of the model may include optimizing the types of hardware used for certain aspects of the computer model 2002 (e.g., co-trained), or may be determined after other parameters for the computer model 2002 are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters 2008 for the computer model 2010. During training, the model parameters 2008 are optimized to “learn” values of the model parameters (such as individual weights, activation values, model execution environment, etc.), that improve the model parameters 2008 based on an optimization function that seeks to improve a cost function (also sometimes termed a loss function). Before training, the computer model 2010 has model parameters 2008 that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 2012 includes a data set to be used for training the computer model 2010. The data set varies according to the particular application and purpose of the computer model 2010. In supervised learning tasks, the training data 2012 typically includes a set of training data labels that describe the training data 2012 and the desired output of the model relative to the training data 2012. For example, for an object classification task, the training data 2012 may include individual images in which individual portions, regions or pixels in the image are labeled with the classification of the object. For this task, the training data 2012 may include a training data image depicting a dog and a person and a training data labels that label the regions of the image that include the dog and the person, such that the computer model 2010 is intended to learn to also label the same portions of that image as a dog and a person, respectively. In another example, the training data 2012 may include various communications to a PSAP labeled with the classification of the communication such that the computer model 2010 is intended to learn to also classify similar communications with the same classification.

To train the computer model 2010, a training module (not shown) applies the training inputs to the computer model 2010 to determine the outputs predicted by the model for the given training inputs. The training module, though not shown, is a computing module used for performing the training of the computer model 2010 by executing the computer model 2010 according to its inputs and outputs given the model's parameters and modifying the model parameters based on the results. The training module may apply the actual execution environment of the computer model 2010, or may simulate the results of the execution environment, for example to estimate the performance, runtime, memory, or circuit area (e.g., if specialized hardware is used) of the computer model 2010. The training module, along with the training data 2012 and model evaluation, may be instantiated in software and/or hardware by one or more processing devices. In various examples, the training process may also be performed by multiple computing systems in conjunction with one another, such as distributed/cloud computing systems. In some examples the training of the computer module 2010 may be different if the computer model 2010 is a large language model (LLM) used for script responses as compared to being used to classify incoming messages to the PSAP. A LLM is used for language-based tasks, whereas the general AI model can be used for a variety of other tasks, including the classification of messages to the PSAP.

After processing the training inputs according to the current model parameters for the computer model 2010, the model's predicted outputs are evaluated and the computer model 2010 is evaluated with respect to the cost function and optimized using an optimization function of the training model. Depending on the optimization function, particular training process and training parameters 2016 after the model evaluation are updated to improve the optimization function of the computer model 2010. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model 2010 and may be measured in various ways, such as the precision (frequency of false positives) and recall (frequency of false negatives). The cost function in some circumstances may also evaluate other characteristics of the model, for example the model complexity, processing speed, memory requirements, physical circuit characteristics (e.g., power requirements, circuit throughput) and other characteristics of the computer model 2010 structure and execution environment (e.g., to evaluate or modify these model parameters).

After determining results of the cost function, the optimization function determines a modification of the model parameters to improve the cost function for the training data 2012. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters 2016 for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data 2012 is batched and the parameter updates are iteratively applied to batches of the training data 2012. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data 2012 available or the incremental improvements in model parameters are below a threshold (e.g., additional training data 2012 no longer continues to improve the model parameters). Additional training parameters 2016 may describe the batch size for the training data 2012, a portion of training data 2012 to use as validation data, the step size of parameter updates, a learning rate of the model, and so forth. Additional techniques may also be used to determine global optimums or address nondifferentiable model parameter spaces.

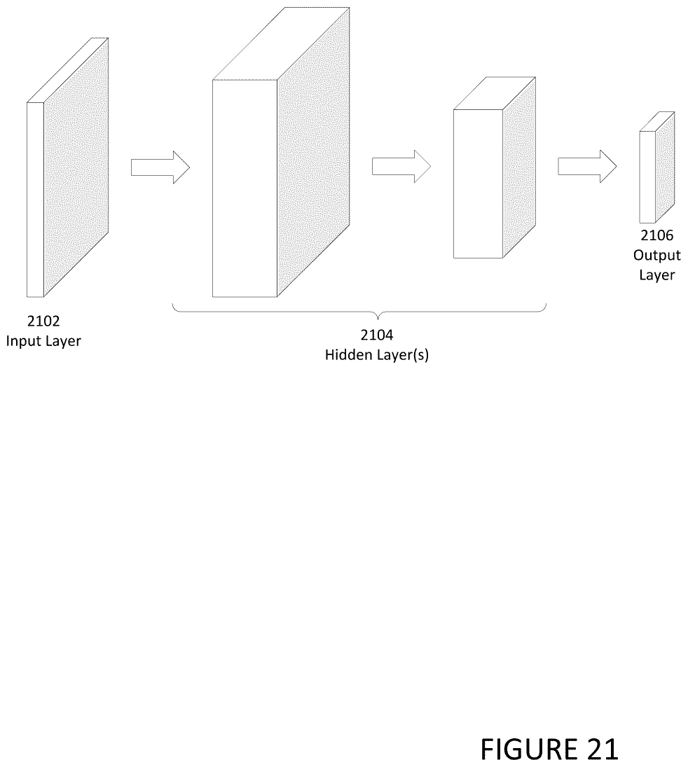

Turning to FIG. 21, FIG. 21 illustrates an example neural network architecture. In general, a neural network includes an input layer 2102, one or more hidden layers 2104, and an output layer 2106. The values for data in each layer of the network is generally determined based on one or more prior layers of the network. Each layer of a network generates a set of values, termed “activations” that represent the output values of that layer of a network and may be the input to the next layer of the network. For the input layer 2102, the activations are typically the values of the input data, although the input layer 2102 may represent input data as modified through one or more transformations to generate representations of the input data. For example, in recommendation systems, interactions between users and objects may be represented as a sparse matrix. Individual users or objects may then be represented as an input layer 2102 as a transformation of the data in the sparse matrix relevant to that user or object. The neural network may also receive the output of another computer model (or several), as its input layer 2102, such that the input layer 2102 of the neural network shown in FIG. 21 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network, except for the final output layer of 2106 of the network.

Each layer of the neural network typically represents its output activations (i.e., also termed its outputs) in a matrix, which may be 1, 2, 3, or n-dimensional according to the particular structure of the network. As shown in FIG. 21, the dimensionality of each layer may differ according to the design of each layer. The dimensionality of the output layer 2106 depends on the characteristics of the prediction made by the model. For example, a computer model for multi-object classification may generate an output layer 2106 having a one-dimensional array in which each position in the array represents the likelihood of a different classification for the input layer 2102. In another example for classification of portions of an image, the input layer 2102 may be an image having a resolution, such as 512×512, and the output layer may be a 512×512×n matrix in which the output layer 2106 provides n classification predictions for each of the input pixels, such that the corresponding position of each pixel in the input layer 2102 in the output layer 2106 is an n-dimensional array corresponding to the classification predictions for that pixel.

The hidden layers 2104 provide output activations that variously characterize the input layer 2102 in various ways that assist in effectively generating the output layer 2106. The hidden layers thus may be considered to provide additional features or characteristics of the input layer 2102. Though two hidden layers are shown in FIG. 21, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 2106. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 2102 is reached.

In the description, various aspects of the illustrative implementations are described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. The terms “substantially,” “close,” “approximately,” “near,” and “about,” generally refer to being within +/−20% of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and a method to enable classifying of communications to a PSAP in that any suitable arrangements, chronologies, configurations, and timing mechanisms may be provided without departing from the teachings of the present disclosure.

Note that embodiments of the electronic device 102, server 104, cloud services 106, network element 108, and the PSAP 110 may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces, may include physical ports (e.g., Ethernet, USB, HDMI, etc.), interfaces for wired and wireless internal subsystems, and the like. Similarly, each of the nodes, the electronic device 102, server 104, cloud services 106, network element 108, and the PSAP 110, IoT devices, wearables, security cameras, detectors, etc. of the communication system 100 can also include suitable interfaces for receiving, transmitting, and/or otherwise communicating data or information in a network environment.

The electronic device 102, server 104, cloud services 106, network element 108, and the PSAP 110 and other associated or integrated components can include one or more memory elements for storing information to be used in achieving operations associated with enabling classifying of communications to a PSAP, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the communication system 100 could be provided in any database, register, table, cache, queue, control list, or storage structure, based on particular needs and implementations, all of which could be referenced in any suitable timeframe. Any of the memory or storage options discussed herein should be construed as being encompassed within the broad term ‘memory element’ as used herein in this Specification.

In example embodiments, the operations for enabling classifying of communications to a PSAP, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out the classifying of communications to a PSAP described in this Specification. Regarding a physical implementation of the electronic device 102, server 104, cloud services 106, network element 108, and the PSAP 110 and their associated components such as the text message engine 114, the audio message engine 116, the communication engine 118, the communication analysis engine 120, etc., any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system, apparatus, and a method to enable classifying of communications to a PSAP and their teachings are readily scalable and can accommodate a large number of components, as well as more complicated/sophisticated arrangements and configurations. Accordingly, the examples provided should not limit the scope or inhibit the broad teachings of the system, apparatus, and method to enable classifying of communications to a PSAP and as potentially applied to a myriad of other architectures.

It is also important to note that the operations in the preceding flow diagrams (i.e., FIGS. 11-19) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method for classifying communications to a public safety answering point (PSAP), the method comprising:
analyzing a communication from an electronic device to a PSAP;
determining a classification for the communication, wherein the classification is one of an emergency PSAP classification, a non-emergency PSAP classification, or a not related to PSAP services classification; and
sending the communication and the determined classification for the communication to a human operator at the PSAP.

2. The method of claim 1, wherein a computer model is used to determine the classification for the communication.

3. The method of claim 2, wherein the computer model is used to request additional details related to the communication to help determine the classification for the communication.

4. The method of claim 1, wherein the communication to the PSAP is intercepted before reaching a human operator at the PSAP.

5. The method of claim 1, wherein the communication to the PSAP is a text communication.

6. The method of claim 1, wherein the communication to the PSAP is an audio communication and the audio communication is converted to text before a classification for the communication is determined.

7. The method of claim 6, further comprising:
subclassifying the communication.

8. The method of claim 7, wherein the subclassifications is one or more of a fire emergency subclassification, a medical emergency subclassification, and/or a crime related emergency subclassification.

9. A method, comprising:
determining a classification for communications destined to a public safety answering point (PSAP), wherein the classification is one of an emergency PSAP classification, a non-emergency PSAP classification, or a not related to PSAP services classification;
sending communications with the emergency PSAP classification to an emergency PSAP communication queue at the PSAP;
sending communications with the non-emergency PSAP classification to a non-emergency PSAP communication queue at the PSAP; and
sending communications with the not related to PSAP services classification to a not related to PSAP services communication queue at the PSAP.

10. The method of claim 9, wherein a computer model is used to determine the classification for the communications.

11. The method of claim 10, wherein the emergency PSAP communication queue is a high priority queue at the PSAP.

12. The method of claim 11, wherein the non-emergency PSAP communication queue is a medium priority queue with a priority lower than the emergency PSAP communication queue.

13. The method of claim 9, wherein the not related to PSAP services communication queue is a low priority queue with a priority lower than the non-emergency PSAP communication queue.

14. The method of claim 9, wherein communications classified as not related to PSAP services include accidental communications, prank communications, and spam communications.

15. A system for classifying communications to a public safety answering point, comprising:
memory;
at least one processor;
a communication analysis engine configured to:
determine a classification for communications destined to a public safety answering point (PSAP), wherein the classification is one of an emergency PSAP classification, a non-emergency PSAP classification, or a not related to PSAP services classification;
send communications with the emergency PSAP classification to a high priority queue at the PSAP;
send communications with the non-emergency PSAP classification to a medium priority queue at the PSAP; and
send communications with the not related to PSAP service classification to a low priority queue.

16. The system of claim 15, wherein the communication analysis engine includes a computer model used to determine the classification for the communication.

17. The system of claim 16, wherein the communication is an audio communication and the communication analysis engine includes a voice to text engine to convert the audio communication to text.

18. The system of claim 15, wherein the communication analysis engine includes a translation engine to translate the communication to a preferred language of a PSAP operator.

19. The system of claim 15, wherein the communication analysis engine collects additional information about the communication.

20. The system of claim 19, wherein the additional information is sent to a PSAP operator.
